(19) United States
(12) Patent Application Publication
(10) Pub. No.: US 2009/0290469 A1
(43) Pub. Date: Nov. 26, 2009

(54) OPTICAL INFORMATION RECORDING MEDIUM, METHOD OF RECORDING INFORMATION, AZO METAL COMPLEX DYE, AND AZO METAL COMPLEX SALT DYE

(75) Inventors: Kousuke Watanabe, Kanagawa (JP); Tetsuya Watanabe, Kanagawa (JP); Taro Hashizume, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/470,131

(22) Filed: May 21, 2009

(30) Foreign Application Priority Data
May 26, 2008 (JP) 2008-136276
Mar. 2, 2009 (JP) 2009-048104

(51) Int. Cl. G11B 7/00; B32B 3/02; C09B 45/18

(52) U.S. Cl. 369/100; 428/64.8; 534/707; G9B/7

(57) ABSTRACT

An aspect of the present invention relates to an optical information recording medium comprising a recording layer on a surface of a support, wherein the recording layer comprises at least one azo metal complex dye that is a complex of at least one azo dye and at least one metal ion, and the azo metal complex dye comprises equal to or more than four bonds, each of the bonds being formed between one azo dye molecule and one metal ion.

### CROSS-REFERENCE TO RELATED APPLICATIONS

This application claims the benefit of priority under 35 USC 119 to Japanese Patent Application No. 2008-136276 filed on May 26, 2008 and Japanese Patent Application No. 2009-048104 filed on Mar. 2, 2009, which are expressly incorporated herein by reference in their entirety.

### BACKGROUND OF THE INVENTION

1. Field of the Invention

The present invention relates to an optical information recording medium permitting the recording and reproduction of information with a laser beam, and more particularly, to a heat mode-type optical information recording medium that is suited to the recording and reproduction of information with a laser beam having a short wavelength of equal to or shorter than 440 nm; and to an information recording method for recording information on the optical information recording medium by irradiation with a laser beam with a short wavelength of equal to or shorter than 440 nm.

The present invention further relates to a novel azo metal complex dye and a novel azo metal complex salt dye that are suitable as recording layer dyes in optical information recording media.

2. Discussion of the Background

Networks, such as the Internet, and high-definition television have recently achieved widespread popularity. With high-definition television (HDTV) broadcasts near at hand, demand is growing for high-capacity recording media for recording image information both economically and conveniently. However, the recordable CD (CD-R) and recordable DVD (DVD-R) do not afford recording capacities that are adequate to handle future needs. Accordingly, to increase the recording density by using a laser beam of even shorter wavelength than that employed in a DVD-R, the development of high-capacity optical disks capable of recording with laser beams of short wavelength (for example, equal to or shorter than 440 nm) is progressing. For example, an optical recording disk with high recording density known as the “Blu-ray Disk” (also referred to as “BD”, hereinafter) and HD-DVD has been proposed as such optical disks.

In optical recording disks employing short-wavelength laser beams (405 nm blue laser beams, for example), reduction in the absorption wavelength of the azo metal complexes employed in DVD-Rs is being studied. Such studies are disclosed in, for example, Japanese Unexamined Patent Publication (KOKAI) Nos. 2001-158862 and 2006-142789, Japanese Unexamined Patent Publication (KOKAI) No. 2006-306070 or English language family member US 2009/0053455 A1, and Japanese Unexamined Patent Publication (KOKAI) No. 2007-26541 or English language family member US 2006/0204706A1, which are expressly incorporated herein by reference in their entirety. Additionally, Japanese Unexamined Patent Publication (KOKAI) No. 2004-291244 discloses an azo metal complex dye that can be applied to both optical information disks employing short-wavelength laser beams and DVD-Rs.

However, the present inventors evaluated the light resistance of dye films and the recording and reproduction characteristics of optical information recording media employing short-wavelength lasers such as blue lasers for the azo metal complexes described in the above-cited publications. The results were unsatisfactory, both in terms of light resistance and recording and reproduction characteristics.

In the inexpensive, large-scale manufacturing of optical information recording media, it is desirable for dye solutions to be stably storable for extended periods when forming recording layers. However, the azo metal complexes described in above-cited publications have been found to afford inadequate storage stability in solution.

### SUMMARY OF THE INVENTION

An aspect of the present invention provides for an optical information recording medium affording good light resistance and good recording characteristics in information recording by irradiation with short-wavelength laser beams (particularly information recording by irradiation with laser beams with wavelengths of equal to or shorter than 440 nm), and a novel compound that affords good storage stability in solution and is suitable for use as a recording layer dye in an optical information recording medium.

The present inventors conducted extensive research into achieving the above medium and compound, resulting in the discovery that the reason that the azo metal complexes described in the above-cited publications did not satisfactorily achieve either of the above properties was that the bond strength between the ligand and the center metal was inadequate.

Accordingly, the present inventors conducted further research based on the above knowledge, resulting in the discovery that azo metal complex dyes having four or more bonds formed between a center metal ion and a single molecule azo dye (ligand) afforded good recording characteristics with short-wavelength laser beams, as well as good light resistance and good storage stability in solution. The present invention was devised on that basis.

An aspect of the present invention relates to an optical information recording medium comprising a recording layer on a surface of a support, wherein
the recording layer comprises at least one azo metal complex dye that is a complex of at least one azo dye and at least one metal ion, and
the azo metal complex dye comprises equal to or more than four bonds, each of the bonds being formed between one azo dye molecule and one metal ion.

The azo metal complex dye may comprise an azo metal complex dye denoted by general formula (1).

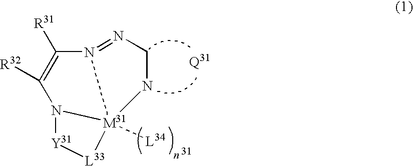

In general formula (1), M³¹ denotes a metal ion, each of L³³ and L³⁴ independently denotes an atom group comprising an atom bonded to M³¹, n³¹ denotes an integer ranging from 0 to 2, two L³⁴s are identical to or different from each other when n³¹ denotes 2, Y³¹ denotes a linking group or a single bond, Q³¹ denotes an atom group forming a nitrogen-containing heterocyclic ring with adjacent carbon and nitrogen atoms, each of R³¹ and R³² independently denotes a hydrogen atom or a substituent, and R³¹ and R³² may bond together to form a ring.

The azo metal complex dye may comprise an azo metal complex dye denoted by general formula (2).

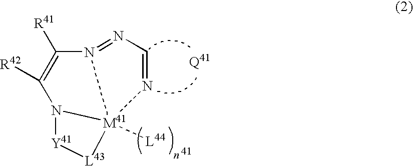

In general formula (2), M⁴¹ denotes a metal ion, L⁴³ denotes an anionic group bonded to M⁴¹, L⁴⁴ denotes an atom group comprising an atom bonded to M⁴¹, n⁴¹ denotes an integer ranging from 0 to 2, two L⁴⁴s are identical to or different from each other when n⁴¹ denotes 2, Y⁴¹ denotes a linking group or a single bond, Q⁴¹ denotes an atom group forming a nitrogen-containing heterocyclic ring with adjacent carbon and nitrogen atoms, each of R⁴¹ and R⁴² independently denotes a hydrogen atom or a substituent, and R⁴¹ and R⁴² may bond together to form a ring.

The azo metal complex dye may comprise an azo metal complex dye denoted by general formula (3-1) and/or an azo metal complex dye denoted by general formula (3-2).

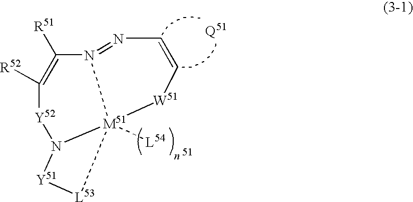

In general formula (3-1), M⁵¹ denotes a metal ion, each of L⁵³ and L⁵⁴ independently denotes an atom group comprising an atom bonded to M⁵¹, n⁵¹ denotes an integer ranging from 0 to 2, two L⁵⁴s are identical to or different from each other when n⁵¹ denotes 2, each of Y⁵¹ and Y⁵² independently denotes a linking group or a single bond, Q⁵¹ denotes an atom group forming a carbon ring or a heterocyclic ring with two adjacent carbon atoms, W⁵¹ denotes an anionic group bonded to M⁵¹, each of R⁵¹ and R⁵² independently denotes a hydrogen atom or a substituent, and R⁵¹ and R⁵² may bond together to form a ring.

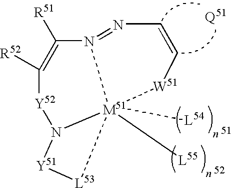

In general formula (3-2), M⁵¹ denotes a metal ion, each of L⁵³ and L⁵⁴ independently denotes an atom group comprising an atom bonded to M⁵¹, L⁵⁵ denotes an anionic ligand bonded to M⁵¹, each of n⁵¹ and n⁵² independently denotes an integer ranging from 0 to 2, two L⁵⁴s are identical to or different from each other when n denotes 2, two L⁵⁵s are identical to or different from each other when n⁵² denotes 2, each of Y⁵¹ and Y⁵² independently denotes a linking group or a single bond, Q⁵¹ denotes an atom group forming a carbon ring or a heterocyclic ring with two adjacent carbon atoms, W⁵² denotes a group forming a coordinate bond with M⁵¹, each of R⁵¹ and R⁵² independently denotes a hydrogen atom or a substituent, and R⁵¹ and R⁵² may bond together to form a ring.

In general formula (1), Y³¹ may denote —SO₂— group or —C(═O)— group.

In general formula (2), Y⁴¹ may denote —SO₂— group or —C(═O)— group.

In general formula (3-1) and/or general formula (3-2), each of Y⁵¹ and Y⁵² may independently denote —SO₂— group or —C(═O)— group.

In general formula (1), the nitrogen-containing heterocyclic ring that is formed with Q³¹ and the adjacent carbon and nitrogen atoms may be a pyrazole ring, imidazole ring, or triazole ring.

In general formula (2), the nitrogen-containing heterocyclic ring that is formed with Q⁴¹ and the adjacent carbon and nitrogen atoms may be a pyrazole ring, imidazole ring, isooxazole ring, 1,2,4-thiadiazole ring, or triazole ring.

In general formula (3-1), the following partial structure:

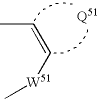

may denote one of the following partial structural formulas (C-1) to (C-5):

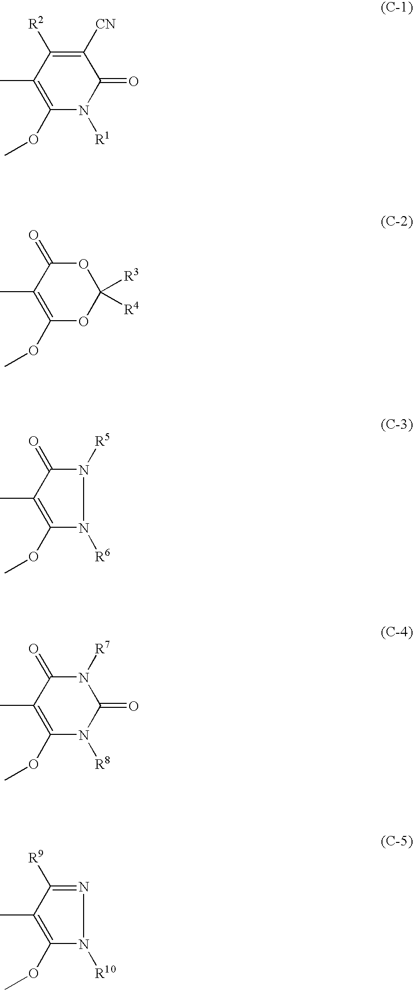

wherein each of R¹ to R¹⁰ independently denotes a hydrogen atom or a substituent, which may be joined with an adjacent substituent to form a ring.

In general formula (3-2), the following partial structure:

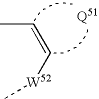

may denote one of the following partial structural formulas (C-1)′ to (C-5)′:

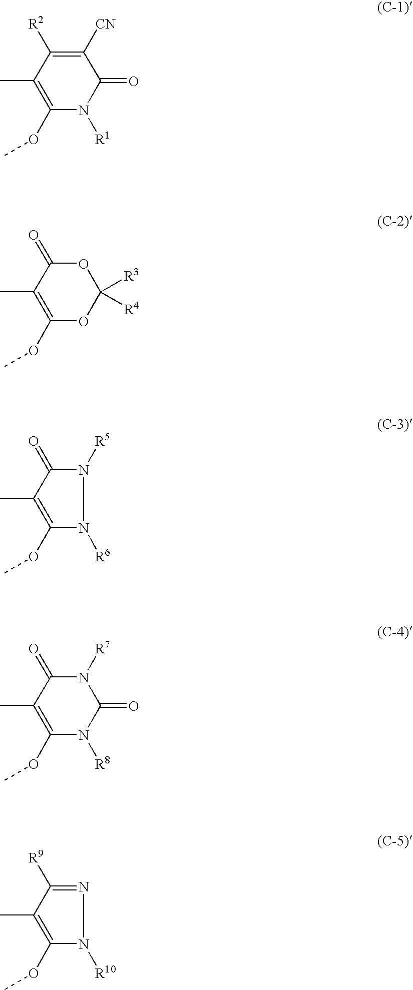

wherein each of R¹ to R¹⁰ independently denotes a hydrogen atom or a substituent, which may be joined with an adjacent substituent to form a ring.

The azo metal complex dye may comprise an azo metal complex dye denoted by general formula (4).

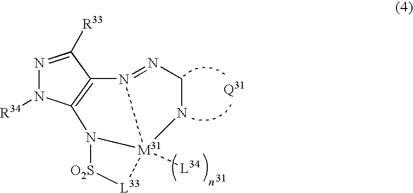

In general formula (4), M³¹ denotes a metal ion, each of L³³ and L³⁴ independently denotes an atom group comprising an atom bonded to M³¹, n³¹ denotes an integer ranging from 0 to 2, two L³⁴s are identical to or different from each other when n³¹ denotes 2, each of R³³ and R³⁴ independently denotes a hydrogen atom or a substituent, and Q³¹ denotes an atom group forming a pyrazole ring, imidazole ring, or triazole ring with adjacent carbon and nitrogen atoms.

The azo metal complex dye may comprise an azo metal complex dye denoted by general formula (5).

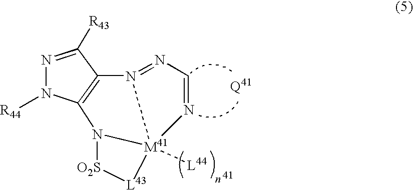

In general formula (5), M⁴¹ denotes a metal ion, L⁴³ denotes an anionic group bonded to M⁴¹ denotes an atom group comprising an atom bonded to M⁴¹, n⁴¹ denotes an integer ranging from 0 to 2, two L⁴⁴s are identical to or different from each other when n⁴¹ denotes 2, each of R⁴³ and R⁴⁴ independently denotes a hydrogen atom or a substituent, and Q⁴¹ denotes an atom group forming a nitrogen-containing heterocyclic ring with adjacent carbon and nitrogen atoms.

The azo metal complex dye may comprise an azo metal complex dye denoted by general formula (6-1) and/or an azo metal complex dye denoted by general formula (6-2).

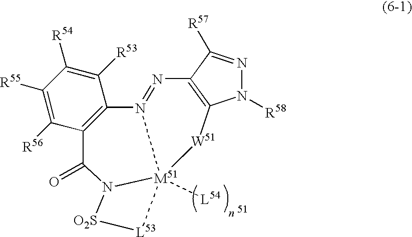

In general formula (6-1), M⁵¹ denotes a metal ion, each of L⁵³ and L⁵⁴ independently denotes an atom group comprising an atom bonded to M⁵¹, n⁵¹ denotes an integer ranging from 0 to 2, two L⁵⁴s are identical to or different from each other when n⁵¹ denotes 2, each of R⁵³ to R⁵⁸ independently denotes a hydrogen atom or a substituent, and W⁵¹ denotes an anionic group bonded to M⁵¹.

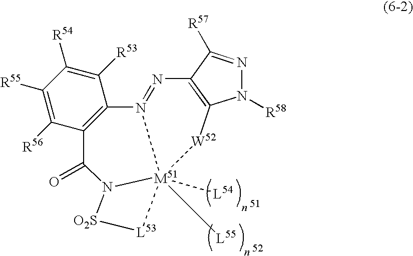

In general formula (6-2), M⁵¹ denotes a metal ion, each of L⁵³ and L⁵⁴ independently denotes an atom group comprising an atom bonded to M⁵¹, L⁵⁵ denotes an anionic ligand bonded to M⁵¹, each of n⁵¹ and n⁵² independently denotes an integer ranging from 0 to 2, two L⁵⁴s are identical to or different from each other when n⁵¹ denotes 2, two L⁵⁵s are identical to or different from each other when n⁵² denotes 2, each of R⁵³ to R⁵⁸ independently denotes a hydrogen atom or a substituent, and W⁵² denotes a group forming a coordinate bond with M⁵¹.

The recording layer may comprise at least one cyanine dye.

The cyanine dye may comprise a cyanine dye cation denoted by general formula (D).

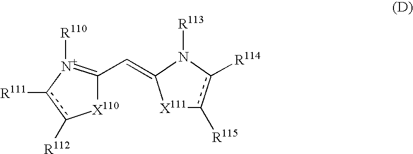

In general formula (D), each of R¹¹⁰, R¹¹¹, R¹¹², R¹¹³, R¹¹⁴, and R¹¹⁵ independently denotes a hydrogen atom or a substituent, R¹¹¹ and R¹¹² may bond together to form a ring structure, R¹¹⁴ and R¹¹⁵ may bond together to form a ring structure, and each of X¹¹⁰ and X¹¹¹ independently denotes a carbon atom, oxygen atom, nitrogen atom, or sulfur atom.

The recording layer may comprise a complex salt of the azo metal complex dye and the cyanine dye cation.

In the optical information recording medium, the surface of the support may have pregrooves with a track pitch ranging from 50 to 500 nm.

In the optical information recording medium, information may be recorded by irradiation of a laser beam having a wavelength of equal to or shorter than 440 μm.

The optical information recording medium may further comprise a reflective layer between the support and the recording layer, and the laser beam may be irradiated onto the recording layer from an opposite surface side, the opposite surface being opposite from the surface facing the reflective layer.

Another aspect of the present invention relates to a method of recording information on the recording layer comprised in the above optical information recording medium by irradiation of a laser beam having a wavelength of equal to or shorter than 440 nm onto the optical information recording medium.

A further aspect of the present invention relates to an azo metal complex dye denoted by the above general formula (4), (5), (6-1), or (6-2).

A still further aspect of the present invention relates to an azo metal complex salt dye of a cyanine dye cation denoted by the above general formula (D) and an azo metal complex dye denoted by the above general formula (4), (5), (6-1) or (6-2).

The azo metal complex dye of an aspect of the present invention can afford good light resistance and exhibit good stability in solution. An aspect of the present invention can provide an optical information recording medium of extremely good light resistance that makes it possible to achieve good recording and reproduction characteristics using a blue laser beam with a wavelength of equal to or shorter than 440 nm (particularly an optical information recording medium permitting the recording of information by irradiation with a laser beam having a wavelength of equal to or shorter than 440 nm).

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a schematic sectional view of an example of the optical information recording medium of the present invention.

Explanations of symbols in the drawings are as follows:
10A First optical information recording medium
12 First support
14 First recordable recording layer
16 Cover layer
18 First light reflective layer
20 Barrier layer
22 First bonding layer or first adhesive layer
42 First objective lens
44 Hard coat layer
46 Laser beam

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

The optical information recording medium, the method of recording information, the azo metal complex dye, and the azo metal complex salt dye of the present invention will be described in detail below.

### Optical Information Recording Medium

The optical information recording medium of the present invention comprises a recording layer on a support, and is suitable as an optical disk for high-density recording, such as a BD or HD-DVD used to record and reproduce information with a short-wavelength laser.

The optical disks for high-density recording are structurally characterized by a narrower track pitch than conventional recordable optical disks. BD-structured optical disks desirably have a layer configuration differing from that of conventional recordable optical disks, comprising a recording layer, either directly or through a layer such as a reflective layer, on the surface of a support having pregrooves with a track pitch of 50 to 500 nm, and having an extremely thin layer with a light-transmitting property on the recording layer (generally known as a “cover layer”). In an optical information recording medium having a narrower track pitch than conventional recordable optical information recording media, by incorporating in a recording layer at least one azo metal complex dye in the form of a complex of an azo dye and a metal ion having four or more bonds, each of the bonds being formed between one azo dye molecule and one metal ion, it becomes possible to achieve good recording and reproduction characteristics. The optical information recording medium of the present invention can afford good recording and reproduction characteristics when irradiated with a laser beam of short wavelength (for example, a wavelength of equal to or shorter than 440 nm). In particular, the optical information recording medium of the present invention is suitable as a BD-configured medium comprising a configuration with a reflective layer between a support and a recording layer. Further, the above azo metal complex dye comprising four or more bonds formed between individual center metal ions and individual molecule azo dyes (ligands) was discovered to exhibit extremely good light resistance and good stability in solution. The optical information recording medium of the present invention incorporates the above azo metal complex dye into the recording layer, thereby achieving both good recording characteristics by irradiation with a short-wavelength laser beam, and a high degree of light resistance. Further, the optical information recording medium of the present invention can be manufactured with high productivity because it can be formed using a recording layer dye with high storage stability in solution.

The azo metal complex dye of the present invention will be described in detail below.

The azo dye and azo metal complex dye in the present invention only describe azo forms in an azo-hydrazone tautomeric equilibrium, but they may also be the corresponding hydrazone forms. In that case, the hydrazone form is to be considered as the same component as the azo form in the present invention.

In the optical information recording medium of the present invention, the azo metal complex dye contained in the recording layer is a complex of at least one azo dye and at least one metal ion. The complex comprises equal to or more than four bonds, each of the bonds being formed between one azo dye (ligand) molecule and one metal ion. When there are fewer than four such bonds, it is difficult to attain the above-stated desirable characteristics. The number of bonds is equal to or more than 4, desirably 4 to 6, and most preferably, from the perspective of ease of synthesis, 4. This number of bonds means the number of bonds formed between a single azo dye ligand and a single metal ion; it does not include additional bonds with other ligands when a metal ion that is bonded to an individual azo dye ligand also forms bonds with other ligands.

Examples of the metal ion forming the complex with the azo dye are ions of the metals: Mg, Al, Si, Ca, Sc, Ti, V, Cr, M, Fe, Co, Ni, Cu, Zn, Ga, Ge, As, Sr, Y, Zr, Nb, Mo, Te, Ru, Rh, Pd, Ag, Cd, In, Sn, Sb, Ba, Pr, Eu, Yb, Hf, Ta, W, Re, Os, Ir, Pt, Au, Hg, Tl, Pb, Bi, and Th. The metal ion may be in the form of a metal oxide ion. Examples of such metal oxide ions are oxides of these metals.

Among the above, ions of transition metal atoms are desirable. The transition metal atoms include the elements of groups IIIa to VIII and group Ib in the Periodic Table of the Elements; they are elements with an incomplete d electron shell. The transition metal atom is not specifically limited. From the perspectives of ease of synthesis and recording characteristics, Mn, Fe, Co, Ni, Cu, and Zn are desirable; Co, Ni, and Cu are preferable; and Cu is of greater preference. From the perspective of effects on the environment and the human body, Fe, Cu, and Zn are desirable.

Divalent and trivalent metal ions are desirable as the metal ion. Examples of divalent and trivalent metal ions are: Mn²⁺, Fe²⁺, Fe³⁺, Co²⁺, Co³⁺, Ni²⁺, Ni³⁺, Cu⁺, Zn²⁺, Cr³⁺, Ru²⁺, Rh³⁺, Pd²⁺, Ir³⁺, and Pt²⁺. From the perspectives of ease of synthesis and recording characteristics, Mn²⁺, Fe²⁺, Fe³⁺, Co²⁺, Co³⁺, Ni²⁺, Ni³⁺, Cu²⁺, and Zn²⁺ are desirable; and Co²⁺, Co³⁺, Ni²⁺, Ni³⁺, and Cu²⁺ are preferred. From the perspective of effects on the environment and the human body, Fe²⁺, Cu²⁺, and Zn²⁺ are desirable.

The azo metal complex dye will be described next.

From the perspective of increasing coordination strength, either of the N atoms in the —N═N— group in an azo metal complex dye is desirably bonded to a metal ion. Forms in which the azo metal complex dye is a dye anion or dye cation are also covered by the present invention. That is, the azo metal complex dye can have a charge within the molecule by comprising an anionic group or cationic group. In that case, the azo metal complex dye will normally be present in the recording layer in the form of a complex salt forming a salt with a paired ion. For example, when the azo metal complex dye is a dye anion, it can be present in the recording layer in a state in which it forms a complex salt with a paired cation. The paired cation is not specifically limited. Examples are the cyanine dye cations described further below.

An example of the azo metal complex dye is denoted by general formula (1) below.

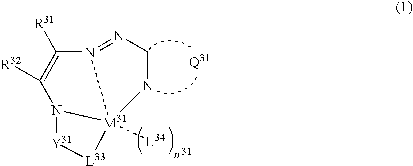

In general formula (1), M³¹ denotes a metal ion. The details of desirable metal ions and the like are as set forth above.

Each of L³³ and L³⁴ independently denotes an atom group comprising an atom bonded to M³¹. While L³³ is a group bonded to Y³¹, L³⁴ is an independent atom group.

Examples of the atom bonded to M³¹ are an oxygen, sulfur, nitrogen, or phosphorus atom.

The atom group bonded by an oxygen atom to M³¹ is not specifically limited. Examples are alcohol ligands (desirably comprising 1 to 30 carbon atoms, preferably 1 to 20 carbon atoms, and more preferably, 1 to 10 carbon atoms, such as a methanol, ethanol, butanol, 2-ethylhexyloxy, or some other monovalent anionic ligand from which a proton has been dissociated), aryloxy ligands (desirably comprising 6 to 30 carbon atoms, preferably 6 to 20 carbon atoms, and more preferably comprising 6 to 12 carbon atoms, such as a phenol, 1-naphthol, 2-naphthol, or some other monovalent anionic ligand from which a proton has been dissociated), diketone ligands (such as an acetylacetone ligand), ether ligands (including cyclic ethers), carboxylic acid ligands, and aqua ligands. These ligands may have substituents.

The atom group bonded by a sulfur atom to M³¹ is not specifically limited. Examples are alkylthiol ligands (desirably comprising 1 to 30 carbon atoms, preferably 1 to 20 carbon atoms, and more preferably, 1 to 12 carbon atoms, such as a monovalent anionic ligand from which a proton has been dissociated, such as butanethiol), arylthiol ligands (desirably comprising 6 to 30 carbon atoms, preferably 6 to 20 carbon atoms, and more preferably, 6 to 12 carbon atoms, such as a thiophenol), and thioether ligands. These ligands may have substituents.

The atom group bonded by a nitrogen atom to M³¹ is not specifically limited. Examples are nitrogen-containing aromatic heterocyclic ligands (such as pyridine ligands, pyrazine ligands, pyrimidine ligands, pyridazine ligands, triazine ligands, thiazole ligands, oxazole ligands, pyrrole ligands, imidazole ligands, pyrazole ligands, triazole ligands, oxadiazole ligands, thiadiazole ligands, condensed ligands containing the same (such as quinoline ligands, benzoxazole ligands, and benzimidazole ligands), and tautomers thereof); amine ligands (such as ammonia, methylamine, dimethylamine, diethylamine, dibenzylamine, triethylamine, piperidine, piperazine, morpholine, and arylamine); aniline ligands (such as aniline, N-methylaniline, N,N-dimethylaniline, N,N-diethylaniline, diphenylamine, N-acylaniline, and N-alkylsulfonylaniline); imine ligands; nitrile ligands (such as acetonitrile ligands); isonitrile ligands (such as t-butylisonitrile ligands); and amide ligands (such as dimethylformamide ligands and dimethylacetamide ligands). These ligands may have substituents.

The atom group bonded by a phosphorus atom to M³¹ is not specifically limited. Examples are alkylphosphine ligands (desirably comprising 2 to 30 carbon atoms, preferably 2 to 20 carbon atoms, more preferably 2 to 10 carbon atoms, such as methylphosphine, dimethylphosphine, diethylphosphine, and dibenzylphosphine); and arylphosphine ligands (desirably comprising 3 to 30 carbon atoms, preferably 4 to 20 carbon atoms, more preferably, 5 to 10 carbon atoms, such as phenylphosphine, diphenylphosphine, and pyridylphosphine). These ligands may have substituents.

Examples of substituents that may be present on the above ligands are those described further below by way of example for the substituents denoted by R³¹ and R³².

n³¹ denotes an integer ranging from 0 to 2; this number can be determined so that the azo metal complex dye assumes a structure of maximum stability. It may vary for solid states and solutions, as well as on the basis of the solvent. When n³¹ denotes 2, the two L³⁴s that are present is identical to or different from each other.

Y³¹ denotes a linking group or a single bond. As a linking group, it is not specifically limited; examples are alkylene, phenylene, —SO₂—, and —C(═O)— groups. —SO₂— and —C(═O)— groups are desirable; an —SO₂— group is preferred.

Q³¹ denotes an atom group forming a nitrogen-containing heterocyclic ring with adjacent carbon and nitrogen atoms. The nitrogen-containing heterocyclic ring that is formed is desirably a pyrazole ring, imidazole ring, or triazole ring; preferably a pyrazole ring or triazole ring; and more preferably; a pyrazole ring. The nitrogen-containing heterocyclic ring may comprise one or more substituents. The details of the substituents are as set forth further below for substituents denoted by R³¹ and R³².

Each of R³¹ and R³² independently denotes a hydrogen atom or a substituent. The substituents are not specifically limited. Examples are alkyl groups (including cycloalkyl groups and bicycloalkyl groups), alkenyl groups (including cycloalkenyl groups and bicycloalkenyl groups), alkynyl groups, aryl groups, heterocyclic groups, cyano groups, carboxyl groups, alkoxy groups, aryloxy groups, silyloxy groups, heterocyclic oxy groups, acyloxy groups, carbamoyloxy groups, alkoxycarbonyloxy groups, aryloxycarbonyloxy groups, amino groups (including anilino groups), acylamino groups, aminocarbonylamino groups, alkoxycarbonylamino groups, aryloxycarbonylamino groups, sulfamoylamino groups, alkyl and arylsulfonylamino groups, mercapto groups, alkylthio groups, arylthio groups, heterocyclic thio groups, sulfamoyl groups, sulfo groups, alkyl and arylsulfinyl groups, alkyl and arylsulfonyl groups, acyl groups, aryloxycarbonyl groups, alkoxycarbonyl groups, carbamoyl groups, aryl and heterocyclic azo groups, and imide groups.

In those of the above functional groups that have hydrogen atoms, the hydrogen atoms can be removed and substituted with the above-listed groups.

The substituents denoted by R³¹ and R³², and the substituent that can be contained in the nitrogen-containing heterocyclic ring formed with Q³¹, may contain a dissociative hydrogen atom or dissociative group and become an anionic or cationic group in the recording layer. The substituents that can be contained in the azo metal complex dye described below, in the same manner as set forth above, may contain a dissociative hydrogen atom or a dissociative group and become anionic or cationic groups in the recording layer. In that case, the azo metal complex dye can be present in the recording layer as a dye anion or dye cation. For example, when an azo metal complex dye such as the azo metal complex dye denoted by general formula (1) becomes a dye anion, it can be present in the recording layer in the form of a complex salt formed with a paired cation. The paired cation is not specifically limited. Examples are the cyanine dye cations described further below. When the azo metal complex dye denoted by general formula (1) is a dye anion, the anionic group is desirably contained in R³¹, R³², or a ring formed by bonding of R³¹ and R³².

It is desirable for R³¹ and R³² to bond together to form a ring. Examples of the ring that is formed are heterocyclic rings and carbon rings. From the perspective of recording characteristics, a heterocyclic ring is desirable.

The carbon ring or heterocyclic ring may comprise one or more substituents, and may be a condensed ring. From the perspective of solubility, a monocyclic ring comprising a substituent is desirable. The substituent is not specifically limited. Examples are: halogen atoms, alkyl groups (including cycloalkyl groups and bicycloalkyl groups), alkenyl groups (including cycloalkenyl groups and bicycloalkenyl groups), alkynyl groups, aryl groups, heterocyclic groups, cyano groups, hydroxyl groups, nitro groups, carboxyl groups, alkoxy groups, aryloxy groups, silyloxy groups, heterocyclic oxy groups, acyloxy groups, carbamoyloxy groups, alkoxycarbonyloxy groups, aryloxycarbonyloxy groups, amino groups (including anilino groups), acylamino groups, aminocarbonylamino groups, alkoxycarbonylamino groups, aryloxycarbonylamino groups, sulfamoylamino groups, alkyl and arylsulfonylamino groups, mercapto groups, alkylthio groups, arylthio groups, heterocyclic thio groups, sulfamoyl groups, sulfo groups, alkyl and arylsulfinyl groups, alkyl and arylsulfonyl groups, acyl groups, aryloxycarbonyl groups, alkoxycarbonyl groups, carbamoyl groups, aryl and heterocyclic azo groups, imide groups, phosphino groups, phosphinyl groups, phosphinyloxy groups, phosphinylamino groups, and silyl groups.

In those of the above functional groups having hydrogen atoms, the hydrogen atoms can be removed and substituted with the above-listed groups.

The ring that is formed by bonding of R³¹ and R³² is not specifically limited. Specific examples are: a benzene ring, pyrrole ring, thiazole ring, oxazole ring, isothiazole ring, isooxazole ring, pyridine ring, pyrazine ring, pyrimidine ring, or pyridazine ring. A benzene ring, pyrazole ring, or pyridine ring is desirable, with a pyrazole ring being preferred.

Specific examples of the azo metal complex dye denoted by general formula (1) will be given below. However, the present invention is not limited thereto.

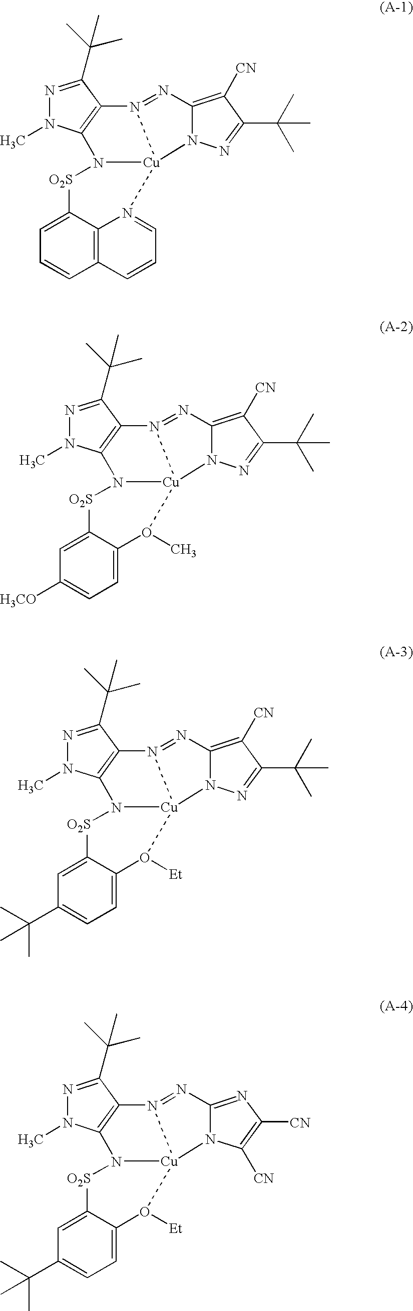

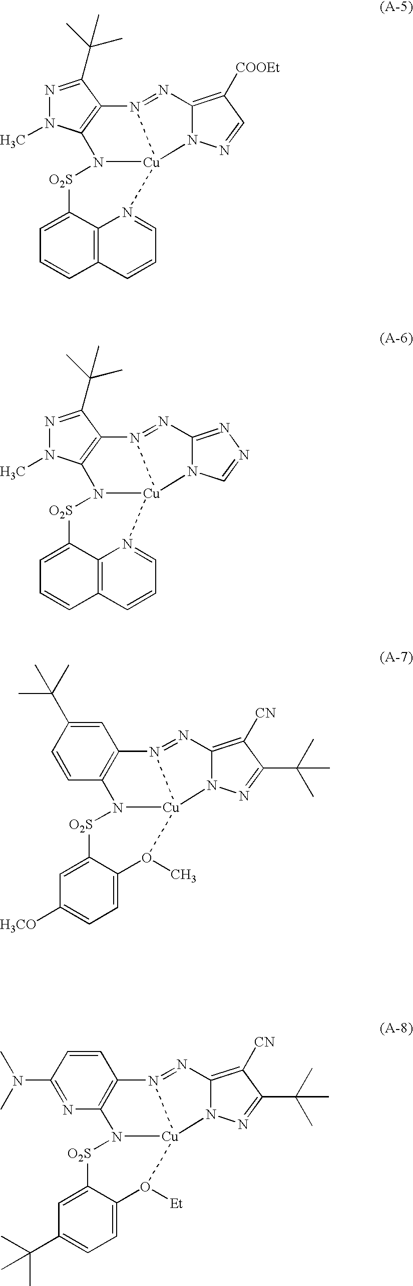

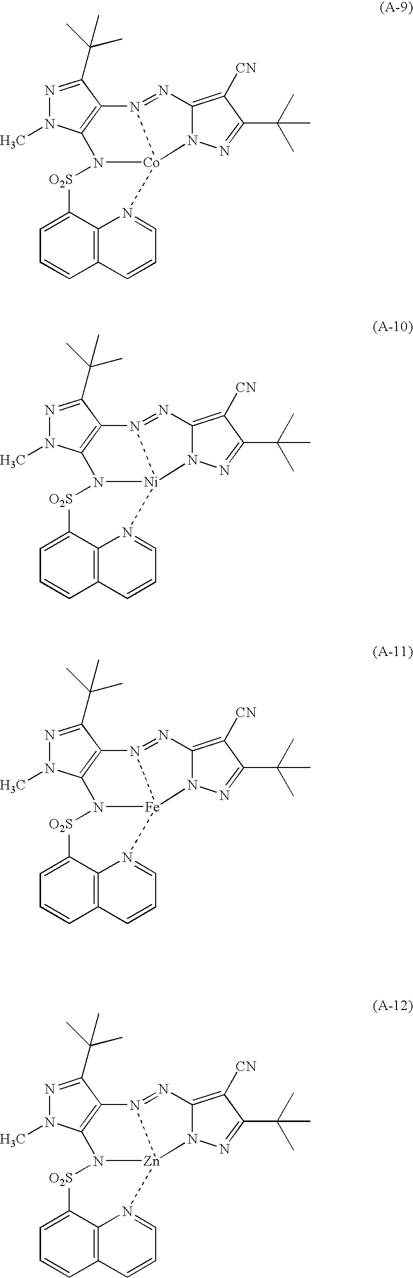

The azo metal complex dye denoted by general formula (2) below is another example of the above azo metal complex dye.

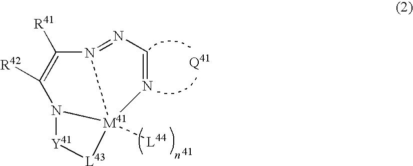

In general formula (2), M⁴¹ is defined identically with M³¹ in general formula (1), and the details thereof, such as the desirable embodiments, are identical thereto.

In general formula (2), Y⁴¹ is defined identically with Y³¹ in general formula (1), and the details thereof, such as the desirable embodiments, are identical thereto.

L⁴⁴ denotes an atom group comprising an atom bonded to M⁴¹. In general formula (2), L⁴⁴ is defined identically with L³⁴ in general formula (1), and the details thereof, such as the desirable embodiments, are identical thereto.

L⁴³ denotes an anionic group bonded to M⁴¹. Examples of the anionic group are anionic groups bonded to M⁴¹ through an oxygen atom, sulfur atom, or nitrogen atom.

The anionic group bonded through an oxygen atom is not specifically limited. Examples are carboxylic acid ligands, sulfonic acid ligands, and phenol ligands. In those ligands comprising hydrogen atoms, the hydrogen atoms can be removed and substituted with the above substituents.

The anionic group bonded through a sulfur atom is not specifically limited. Examples are thiophenol ligands. In those ligands comprising hydrogen atoms, the hydrogen atoms can be removed and substituted with substituents.

The anionic group bonded through a nitrogen atom is not specifically limited. Examples are aniline ligands, amide ligands, and sulfonamide ligands. In those ligands comprising hydrogen atoms, the hydrogen atoms can be removed and substituted with substituents.

Examples of substituents that can be present on the above ligands are the substituents given by way of example above for substituents denoted by R³¹ and R³².

n⁴¹ denotes an integer ranging from 0 to 2. When n⁴¹ denotes 2, the two L⁴⁴s that are present is identical to or different from each other. n⁴¹ in general formula (2) is defined identically with n³¹ in general formula (1).

Each of R⁴¹ and R⁴² independently denotes a hydrogen atom or a substituent, and they may bond together to form a ring.

R⁴¹ and R⁴² in general formula (2) are identically defined with R³¹ and R³² in general formula (1), and the details thereof, such as desirable embodiments, are identical thereto.

Q⁴¹ denotes an atom group forming a nitrogen-containing heterocyclic ring with adjacent carbon and nitrogen atoms. The nitrogen-containing heterocyclic group is not specifically limited. Examples are: a pyrazole ring, imidazole ring, thiazole ring, oxazole ring, isothiazole ring, isooxazole ring, 1,3,4-thiadiazole ring, 1,3,4-oxadiazole ring, 1,2,4-thiadiazole ring, 1,2,4-oxadiazole ring, triazole ring, pyridine ring, pyrazine ring, pyrimidine ring, pyridazine ring, and triazine ring. A pyrazole ring, imidazole ring, isothiazole ring, isooxazole ring, 1,3,4-thiadiazole ring, 1,3,4-oxadiazole ring, 1,2,4-thiadiazole ring, 1,2,4-oxadiazole ring, or triazole ring is desirable. A pyrazole ring, imidazole ring, isooxazole ring, 1,3,4-thiadiazole ring, 1,2,4-thiadiazole ring, or triazole ring is preferred. A pyrazole ring, isooxazole ring, or 1,3,4-thiadiazole ring is of greater preference. And a pyrazole ring is particularly preferred.

When the azo metal complex dye denoted by general formula (2) is a dye anion, the anionic group is desirably contained on R⁴¹, R⁴², or a ring formed by the bonding of R⁴¹ and R⁴².

Specific examples of the azo metal complex dye denoted by general formula (2) will be given below. However, the present invention is not limited thereto.

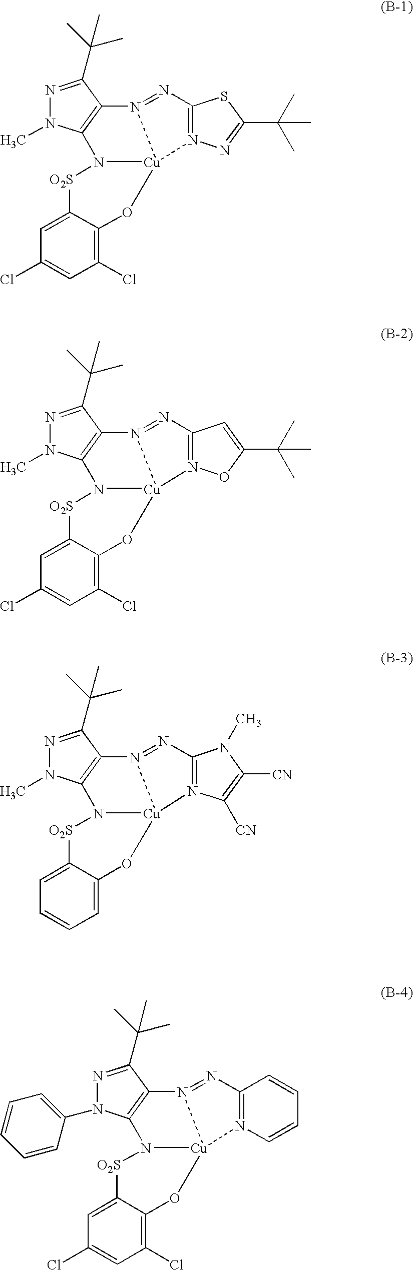

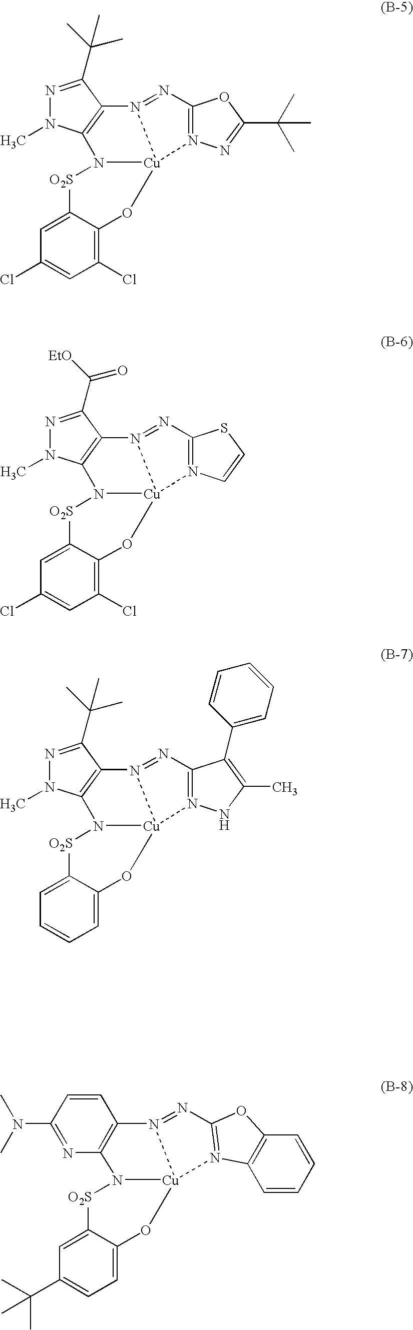

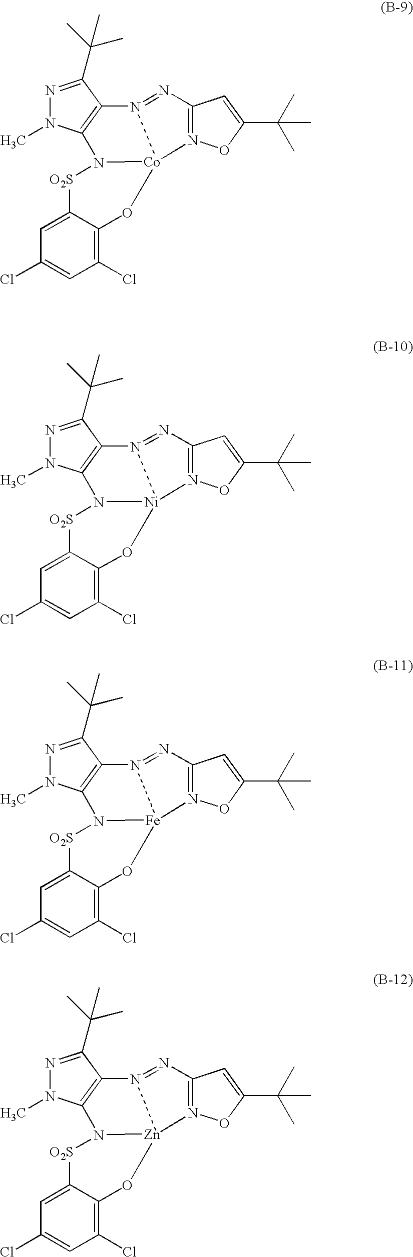

The azo metal complex dye denoted by general formula (3-1) is another example of the above azo metal complex dye.

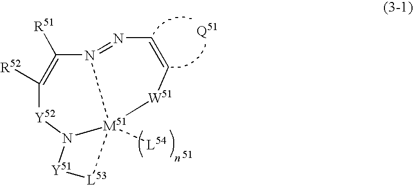

In general formula (3-1), M⁵¹, Y⁵¹, and L⁵³ are defined identically with M³¹, Y³¹, and L³³, respectively, in general formula (1) and the details thereof, such as desirable embodiments, are identical thereto.

Y⁵² denotes a linking group or a single bond. As a linking group, it is not specifically limited. Examples are the linking groups given by way of example for the linking group denoted by Y³¹ in general formula (1). Y⁵² desirably denotes a single bond, a —SO₂— group, or a —C(═O)— group, preferably denotes a single bond or a —C(═O)— group, and more preferably denotes a —C(═O)— group.

In general formula (3-1), L⁵⁴ is defined identically with L³⁴ in general formula (1) and the details thereof, such as desirable embodiments, are identical thereto.

In general formula (3-1), n⁵¹ is defined identically with n³¹ in general formula (1).

Each of R⁵¹ and R⁵² independently denotes a hydrogen atom or a substituent. Examples of the substituents are those given by way of example for the substituents denoted by R³¹ and R³² in general formula (1). R⁵¹ and R⁵² desirably bond together to form a ring. The ring formed by the bonding of R⁵¹ and R⁵² is desirably either a carbon ring or a heterocyclic ring; a monocyclic ring is desirable, and a benzene ring is preferred.

Q⁵¹ denotes an atom group forming a carbon ring or a heterocyclic ring with two adjacent carbon atoms. When the ring structure formed by Q⁵¹ is a heterocyclic ring, it may be a heterocyclic ring formed of carbon atoms and hetero atoms (such as oxygen atoms, sulfur atoms, nitrogen atoms, or the like). There is no specific limitation in this regard. Examples are: pyrazole, pyrrole, furan, thiofuran, imidazole, thiazole, isothiazole, oxazole, isooxazole, pyridine, pyrazine, pyrimidine, and pyridazine rings, as well as the rings included in (C-1) to (C-5) further below. These rings may have substituents, and may be condensed rings.

A benzene ring is desirable as the carbon ring formed by Q⁵¹. The benzene ring may have one or more substituents. It may be a condensed ring, but is not condensed into a 10π system (such as a naphthalene ring or a quinoline ring), or a 14π system (such as anthracene, phenanthrene, or phenanthroline). From the perspective of enhancing solubility, it desirably comprises one or more substituents. When the azo metal complex dye denoted by general formula (3-1) is a dye anion, the anionic group is desirably contained in a nitrogen-containing heterocyclic group formed by Q⁵¹.

W⁵¹ denotes an anionic group bonded to M⁵¹. Examples of the anionic group bonded to M⁵¹ are: a hydroxyl group, amino group (desirably an amino group, a substituted or unsubstituted alkylamino group having 1 to 30 carbon atoms, or a substituted or unsubstituted anilino group having 6 to 30 carbon atoms, such as an amino group, methylamino group, dimethylamino group, anilino group, N-methylanilino group, or diphenylamino group); acylamino group (desirably a formylamino group, substituted or unsubstituted alkylcarbonylamino group having 1 to 30 carbon atoms, or substituted or unsubstituted arylcarbonylamino group having 6 to 30 carbon atoms, such as a formylamino group, acetylamino group, pivaloylamino group, lauroylamino group, benzoylamino group, or 3,4,5-tri-n-octyloxyphenylcarbonylamino group); aminocarbonylamino group (desirably a substituted or unsubstituted aminocarbonylamino group having 1 to 30 carbon atoms, such as a carbamoylamino group, N,N-dimethylaminocarbonylamino group, N,N-diethylaminocarbonylamino group, or morpholinocarbonylamino group); alkoxycarbonylamino group (desirably a substituted or unsubstituted alkoxycarbonylamino group having 2 to 30 carbon atoms, such as a methoxycarbonylamino group, ethoxycarbonylamino group, t-butoxycarbonylamino group, n-octadecyloxycarbonylamino group, or N-methylmethoxycarbonylamino group); aryloxycarbonylamino group (desirably a substituted or unsubstituted aryloxycarbonylamino group having 7 to 30 carbon atoms, such as a phenoxycarbonylamino group, p-chlorophenoxycarbonylamino group, or m-n-octyloxyphenoxycarbonylamino group); sulfamoylamino group (desirably a substituted or unsubstituted sulfamoylamino group having 0 to 30 carbon atoms, such as a sulfamoylamino group, N,N-dimethylaminosulfonylamino group, or N-n-octylaminosulfonylamino group); or an alkyl or arylsulfonylamino group (desirably a substituted or unsubstituted alkylsulfonylamino group having 1 to 30 carbon atoms or a substituted or unsubstituted arylsulfonylamino group having 6 to 30 carbon atoms, such as a methylsulfonylamino group, butylsulfonylamino group, phenylsulfonylamino group, 2,3,5-trichlorophenylsulfonylamino group, or p-methylphenylsulfonylamino group). When W⁵¹ denotes an amino group having one or more substituents, the substituent may bond with the atom group denoted by Q⁵¹ to form a ring.

The anionic group bonded to M⁵¹ is desirably a hydroxyl group, substituted or unsubstituted acylamino group, substituted or unsubstituted aminocarbonylamino group, substituted or unsubstituted alkoxycarbonylamino group, substituted or unsubstituted aryloxycarbonylamino group, sulfamoylamino group, substituted or unsubstituted alkylsulfonylamino group, or substituted or unsubstituted arylsulfonylamino group; preferably a hydroxyl group, sulfamoylamino group, substituted or unsubstituted alkylsulfonylamino group, or substituted or unsubstituted arylsulfonylamino group; more preferably a hydroxyl group or sulfamoylamino group; and particularly preferably, a hydroxyl group.

In general formula (3-1), the following partial structure:

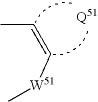

desirably denotes one of following partial structural formulas (C-1) to (C-5).

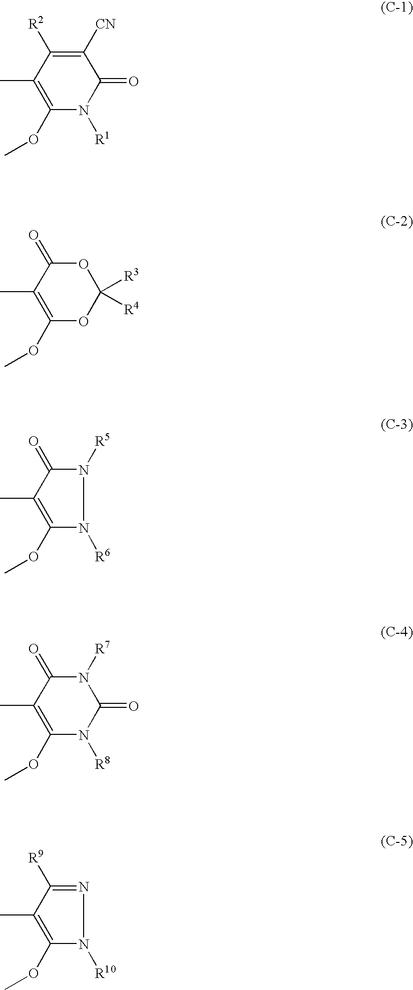

In the above partial structural formulas, each of R¹ to R¹⁰ independently denotes a hydrogen atom or a substituent, which may be joined with an adjacent substituent to form a ring. The substituents are not specifically limited. Examples are the substituents given by way of example for the substituents denoted by R³¹ and R³² in general formula (1). Substituted and unsubstituted alkyl groups and substituted and unsubstituted aryl groups are desirable. From the perspective of solubility, substituted and unsubstituted alkyl groups are preferred.

The above partial structure is preferably (C-1), (C-3), (C-4), or (C-5); more preferably (C-3), (C-4), or (C-5); and still more preferably, (C-5).

Specific examples of the azo metal complex dye denoted by general formula (3-1) will be given below. However, the present invention is not limited thereto.

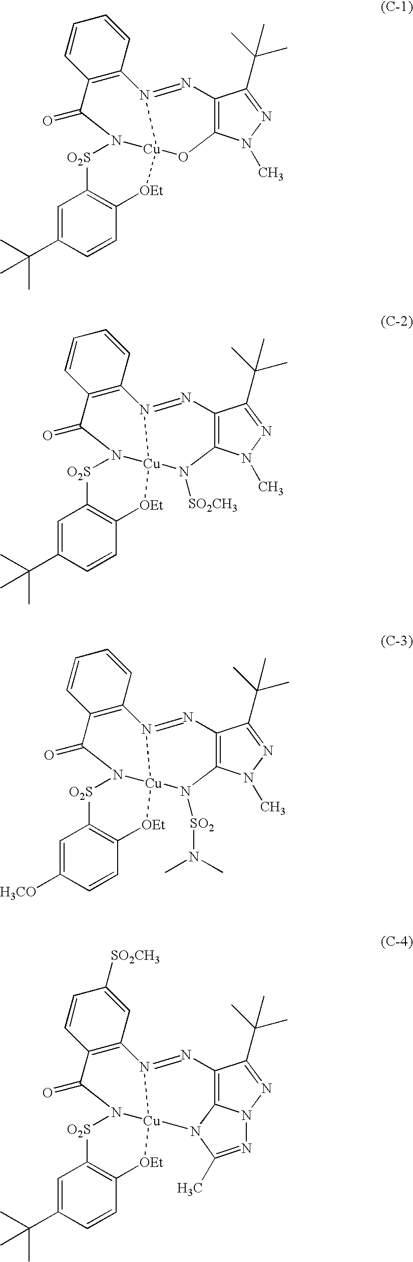

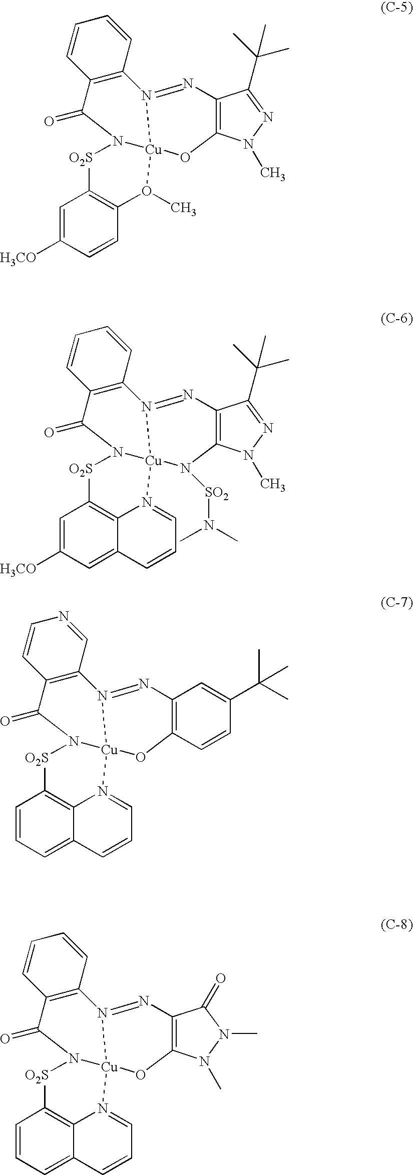

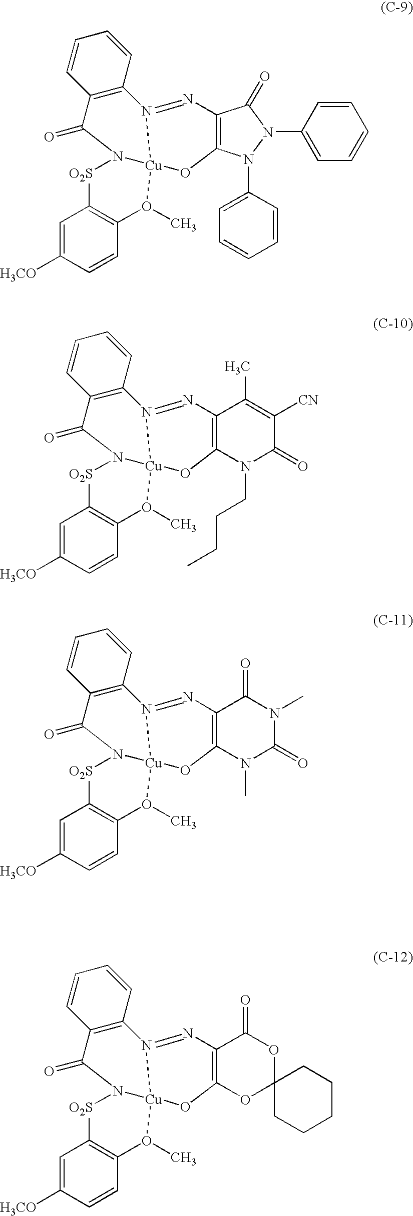

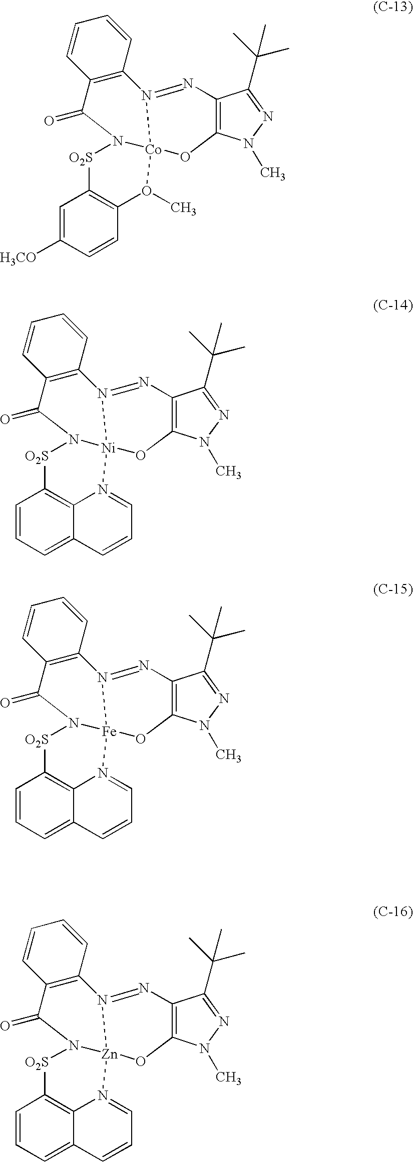

The above azo metal complex dye may be an azo metal complex dye denoted by general formula (3-2) below.

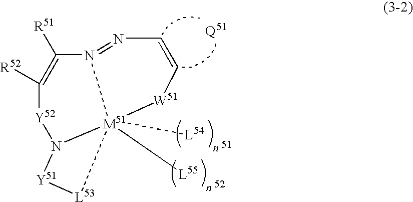

In general formula (3-2), M⁵¹, L⁵³, L⁵⁴, n⁵¹, R⁵¹, R⁵², Y⁵¹, Y⁵² and Q⁵¹ are identically defined with M⁵¹, L⁵³, L⁵⁴, n⁵¹, R⁵¹, R⁵², Y⁵¹, Y⁵² and Q⁵¹ in general formula (3-1), respectively, and details of the desirable embodiments thereof and the like are identical thereto.

W⁵² denotes a group forming a coordinate bond with M⁵¹. The group forming a coordinate bond with M⁵¹ is not specifically limited. Examples are: an amino group, alkoxy group, aryloxy group, thioalkoxy group, or thioaryloxy group. These may also be substituted. Examples of the substituents are the substituents set forth above. The group forming a coordinate bond with M⁵¹ is desirably an amino group or an alkoxy group, preferably an amino group.

L⁵⁵ denotes an anionic ligand bonded to M⁵¹. L⁵⁵ is not specifically limited. Examples are ligands such as halogen ions, acetic acid ions, sulfuric acid ions, nitric acid ions, and hydroxide ions.

n⁵² denotes an integer ranging from 0 to 2. n⁵² is desirably 0 or 1.

In general formula (3-2), the following partial structure:

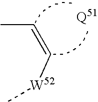

desirably denotes one of the following partial structural formulas (C-1)′ to (C-5)′; preferably (C-1)′, (C-3)′, (C-4)′, or (C-5)′; more preferably (C-3)′, (C-4)′, or (C-5)′; and still more preferably, (C-5)′.

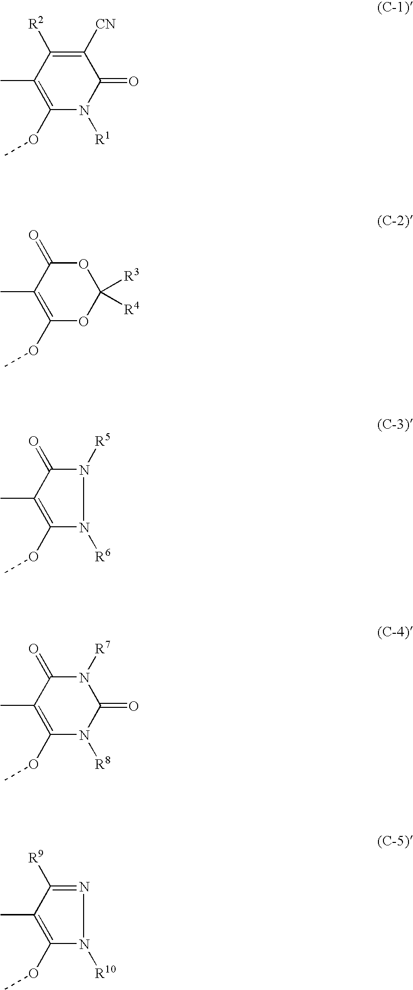

The above R¹ to R¹⁰ are as described for R¹ to R¹⁰ in (C-1) to (C-5).

Specific examples of the azo metal complex dye denoted by general formula (3-2) will be given below. However, the present invention is not limited thereto.

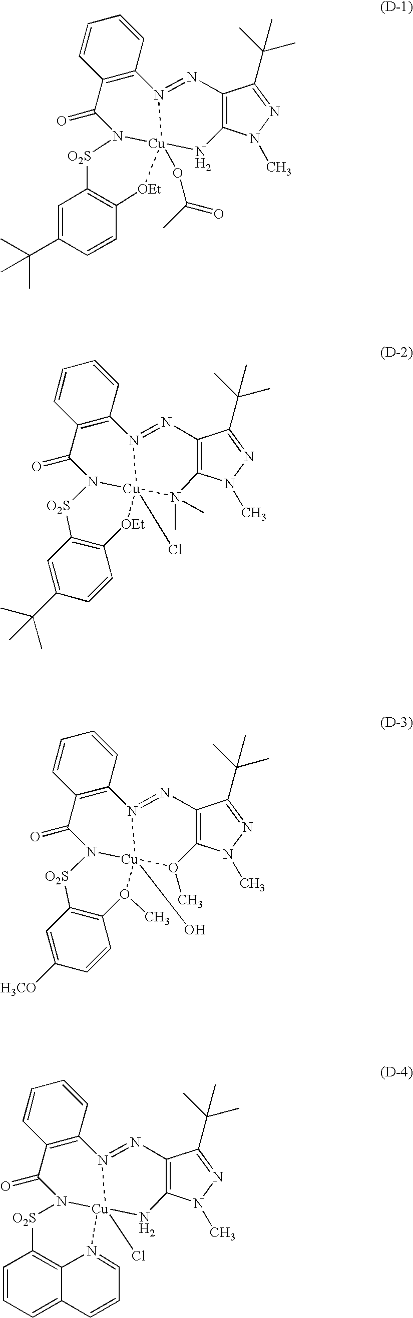

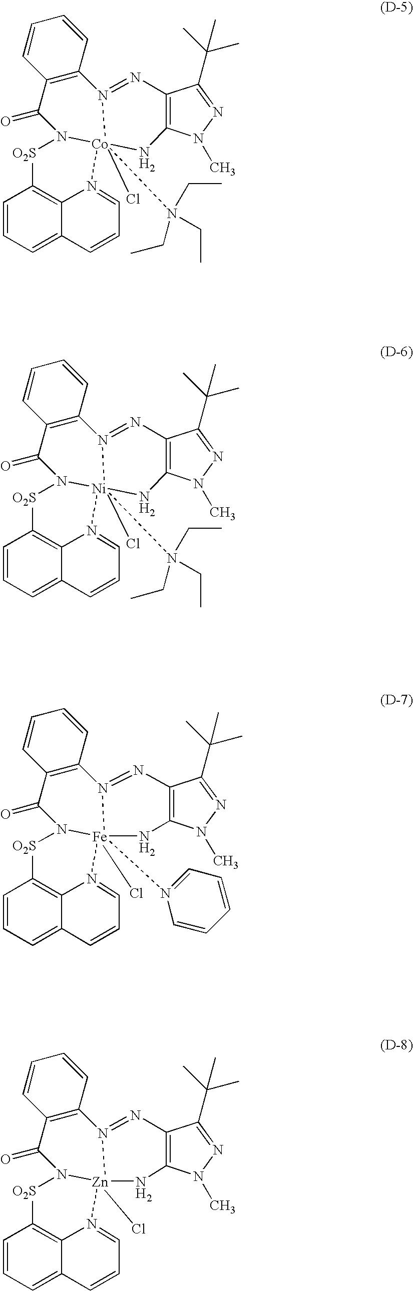

The azo metal complex dye denoted by general formula (4) below is an example of a desirable embodiment of the azo metal complex dye denoted by general formula (1).

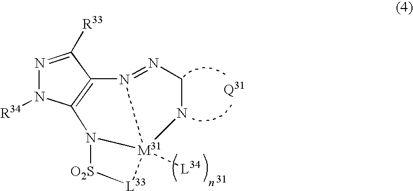

In general formula (4), M³¹, L³³, L³⁴, and n³¹ are identically defined with M³¹, L³³, L³⁴, and n³¹ in general formula (1), and details of the desirable embodiments thereof and the like are identical thereto.

Q³¹ denotes an atom group forming a pyrazole ring, imidazole ring, or triazole ring with adjacent carbon and nitrogen atoms. The above ring structure may comprise one or more substituents. The details of the substituents are identical to those of the substituents that can be contained by Q³¹ in general formula (1). When the azo metal complex dye denoted by general formula (4) is a dye anion, the anionic group is desirably contained in R³³ or R³⁴.

Each of R³³ and R³⁴ independently denotes a hydrogen atom or a substituent. The substituents are not specifically limited. Examples are the substituents set forth above. R³³ and R³⁴ desirably denote substituents; preferably denote alkyl groups or aryl groups; and more preferably, alkyl groups.

The azo metal complex dye denoted by general formula (5) below is an example of a desirable embodiment of the azo metal complex dye denoted by general formula (2).

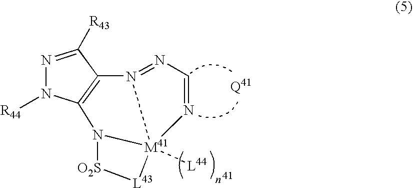

In general formula (5), M⁴¹, L⁴³, L⁴⁴, n⁴¹, and Q⁴¹ are identically defined with M⁴¹, L⁴³, L⁴⁴, n⁴¹, and Q⁴¹ in general formula (2), and details of the desirable embodiments thereof and the like are identical thereto.

R⁴³ and R⁴⁴ in general formula (5) are identically defined with R³³ and R³⁴ in general formula (4), and details of the desirable embodiments thereof and the like are identical thereto.

When the azo metal complex dye denoted by general formula (5) is a dye anion, the anionic group is desirably contained in R⁴³ or R⁴⁴.

The azo metal complex dye denoted by general formula (6-1) below is an example of a desirable embodiment of the azo metal complex dye denoted by general formula (3-1).

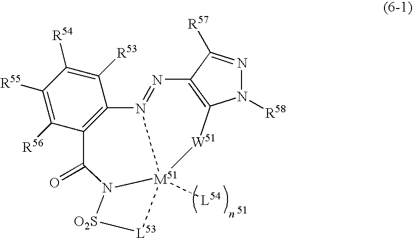

In general formula (6-1), W⁵¹, M⁵¹, L⁵³, L⁵⁴, and n⁵¹ are identically defined with W⁵¹, M⁵¹, L⁵³, L⁵⁴, and n⁵¹ in general formula (3-1), and details of the desirable embodiments thereof and the like are identical thereto.

Each of R⁵³ to R⁵⁸ independently denotes a hydrogen atom or a substituent. Examples of the substituents are those set forth above. R⁵⁷ and R⁵⁸ desirably denote substituents, preferably alkyl groups or aryl groups, and more preferably, alkyl groups. R⁵³ to R⁵⁶ desirably denote hydrogen atoms.

When the azo metal complex dye denoted by general formula (6-1) is a dye anion, the anionic group is desirably contained in R⁵⁷ or R⁵⁸.

The azo metal complex dye denoted by general formula (6-2) below is a n example of a desirable embodiment of the azo metal complex dye denoted by general formula (3-2).

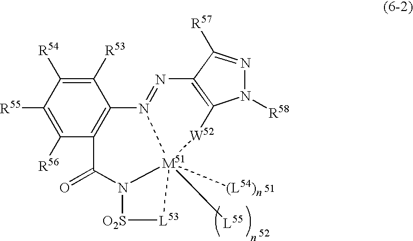

In general formula (6-2), M⁵¹, L⁵³, L⁵⁴, n⁵¹, and R⁵³ to R⁵⁸ are identically defined with M⁵¹, L⁵³, L⁵⁴, n⁵¹, and R⁵³ to R⁵⁸ in general formula (6-1), and details of the desirable embodiments thereof and the like are identical thereto.

In general formula (6-2), W⁵², L⁵⁵, and n⁵² are identically defined with W⁵², L⁵⁵, and n⁵² in general formula (3-2), and details of the desirable embodiments thereof and the like are identical thereto.

When the azo metal complex dye denoted by general formula (6-2) is a dye anion, the anionic group is desirably contained in R⁵⁷ or R⁵⁸.

The above-described azo metal complex can be a complex comprising constituent components in the form of an azo dye and a metal ion. Additional components, such as ions required to neutralize the charges of the ligands or molecules, can be incorporated with the azo dye and metal ion.

The method of synthesizing the above azo metal complex dye will be described next.

The methods described in Japanese Unexamined Patent Publication (KOKAI) Showa No. 61-36362 and Japanese Unexamined Patent Publication (KOKAI) No. 2006-57076, which are expressly incorporated herein by reference in their entirety, are examples of general methods of synthesizing the azo dye in the present invention. However, the method is not limited thereto. Other reaction solvents and acids may be employed. Further, the coupling reaction may be conducted in the presence of a base (such as sodium acetate, pyridine, or sodium hydroxide).

The following is an example of a general method of reacting an azo dye and a metal ion to obtain a metal azo chelate dye. An azo dye and a metal salt (including metal complexes and metal oxide salts) are stirred in an organic solvent, water, or a mixed solution thereof. Neither the type of metal salt, the type of organic solvent or mixed solution thereof, the reaction temperature, or the like is limited. The reaction can be conducted in the presence of a base. The type of base is not specifically limited. In the present invention, the reaction is desirably conducted in the presence of a base.

A specific example of a method of synthesizing the azo metal complex dye is the method of hot refluxing employing a reaction solvent in the form of an alcohol solvent such as methanol or ethanol, and a base in the form of an amine, amidine (such as DBU), guanidine, or an inorganic base (such as NaOH). However, the method is not limited thereto. It suffices to suitably determine the reaction solvent, the concentrations of the azo dye and metal salt in the reaction solution, the mixing ratio, the reaction temperature and reaction time, and other reaction conditions.

The structure of the azo metal complex can be determined by a known method such as ESI-MS, MALDI-MS, ESR, or X-ray structural analysis.

The optical information recording medium of the present invention comprises a recording layer comprising at least one azo metal complex dye in the form of a complex of at least one azo dye compound and at least one metal ion, wherein the complex comprises equal to or greater than four bonds, each of the bonds being formed between one azo dye molecule and one metal ion. The recording layer may comprise one or more types of such azo metal complex dyes. The content of the azo metal complex dye in the recording layer, for example, falls within a range of 1 to 100 weight percent, desirably within a range of 70 to 100 weight percent, more preferably within a range of 80 to 100 weight percent, and optimally, within a range of 90 to 100 weight percent, of the total weight of the recording layer.

The azo metal complex dye can afford good properties, as set forth above. However, in some cases, its use in combination with other components can further enhance its properties. It suffices to optimally select the components used in combination to enhance its properties based on the objective. An example of a component that is suitably employed in combination is a cyanine dye. Based on research conducted by the present inventors, combined use with a cyanine dye can enhance recording sensitivity. This is attributed to the fact that cyanine dyes have a sensitizing effect. In the present invention, the term “cyanine dye” means a methine dye in which an alternating conjugate system constituting a chromophore is terminated by a hetero atom having a positive charge, so that the positive charge is nonlocalized over the entire conjugate system.

The cyanine dye comprising a cationic dye moiety (cyanine dye cation) denoted by general formula (D) below is an example of a cyanine dye that is desirably employed in combination with the azo metal complex dye. In general formula (D), [symbol] denotes a single bond or a double bond.

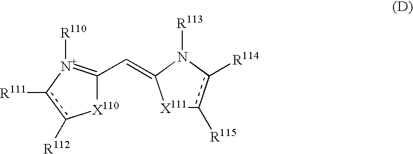

In general formula (D), each of R¹¹⁰, R¹¹¹, R¹¹², R¹¹³, R¹¹⁴, and R¹¹⁵ independently denotes a hydrogen atom or a substituent. R¹¹¹ and R¹¹², and R¹¹⁴ and R¹¹⁵ may bond together to form ring structures. Each of X¹¹⁰ and X¹¹¹ independently denotes a carbon atom, oxygen atom, nitrogen atom, or sulfur atom.

General formula (D) will be described in greater detail below.

In general formula (D), each of X¹¹⁰ and X¹¹¹ independently denotes a carbon atom, oxygen atom, nitrogen atom, or sulfur atom. From the perspective of the sensitizing effect on the azo metal complex dye, X¹¹⁰ and X¹¹¹ desirably denote sulfur atoms or oxygen atoms.

Each of R¹¹⁰, R¹¹¹, R¹¹², R¹¹³, R¹¹⁴, and R¹¹⁵ independently denotes a hydrogen atom or a substituent. Examples of the substituents are the groups given by way of example for the substituents denoted by R³¹ and R³² in general formula (1). These substituents are desirably substituted or unsubstituted alkyl groups having 1 to 10 carbon atoms or substituted or unsubstituted aryl groups having 6 to 10 carbon atoms; preferably substituted or unsubstituted alkyl groups having 1 to 10 carbon atoms; and more preferably, substituted or unsubstituted alkyl groups having 1 to 4 carbon atoms. Examples of substituents substituted onto these various groups are the groups given by wave of example for the substituents denoted by R³¹ and R³² in general formula (1). From the perspective of enhancing solubility, R¹¹⁰ and R¹¹³ are desirably substituted.

R¹¹¹ and R¹¹², and R¹¹⁴, and R¹¹⁵, may bond together to form a ring structure. When R¹¹¹ and R¹¹², and R¹¹⁴ and R¹¹⁵ are bonded together to form a ring structure, [symbol] desirably denotes a double bond, and is desirably part of an aromatic ring. When part of an aromatic ring, the aromatic ring is desirably a substituted or unsubstituted benzene ring.

When R¹¹¹ and R¹¹², and R¹¹⁴ and R¹¹⁵, bond together to form a ring structure, the following condensed rings are examples of a condensed ring formed with R¹¹¹, R¹¹² and a nitrogen-containing five-membered ring on which R¹¹¹ and R¹¹² substitute and those of a condensed ring formed with R¹¹⁴, R¹¹⁵ and a nitrogen-containing five-membered ring on which R¹¹⁴ and R¹¹⁵ substitute.

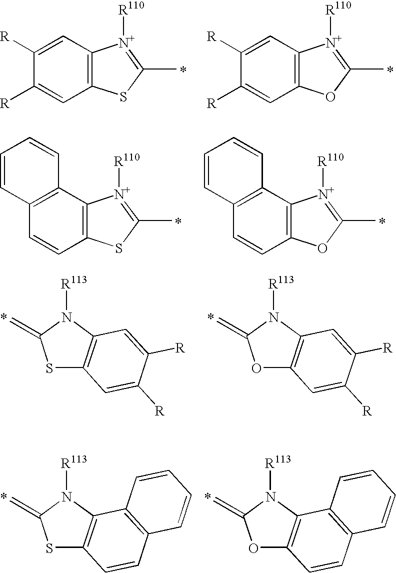

In the above formulas, R denotes a hydrogen atom or a substituent (such as an alkyl group or halogen atom). The plural Rs that are present is identical to or different from each other. “*” denotes a bonding position with a carbon atom.

Specific examples of the cationic dye moiety denoted by general formula (D) will be given below. However, the present invention is not limited thereto.

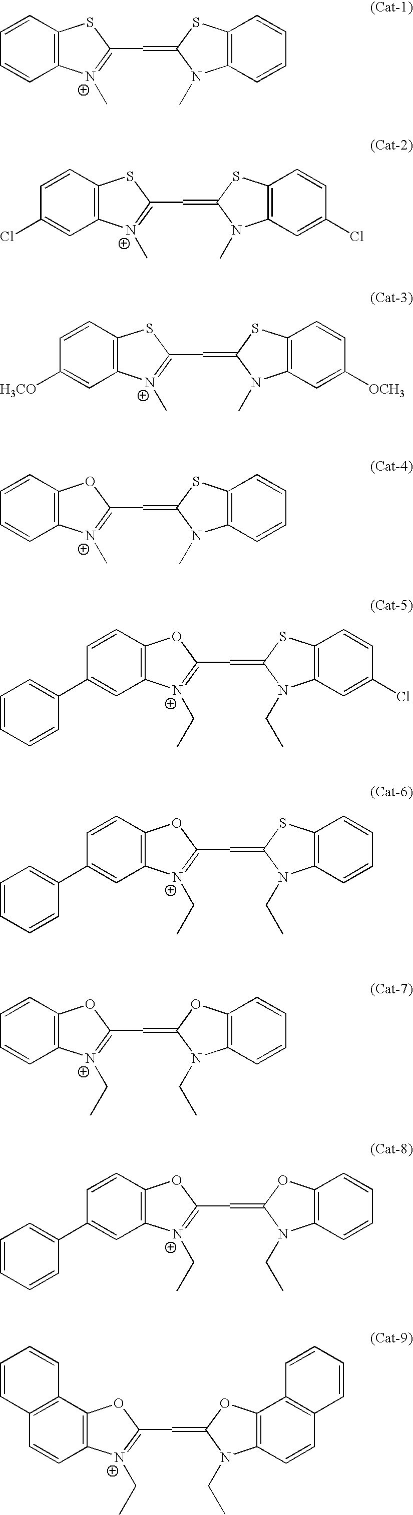

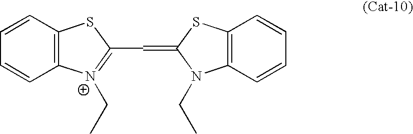

The cyanine dye having a cationic dye moiety denoted by general formula (D) can be synthesized by known methods and is available as a commercial product. Methods of synthesis are described in detail in “The Chemistry of Synthetic Dyes,” (Academic Press, by K. Venkataraman, 1971) and the references provided therein, for example. Reference can also be made to WO 01/44374 and the like. The contents of the above publications are expressly incorporated herein by reference in their entirety.

The cyanine dye having a cationic dye moiety denoted by general formula (D) is normally present in a state in which the cationic dye moiety denoted by general formula (D) forms a salt with one or more paired anions in a quantity that neutralizes the charge within the molecule. The paired anions need only be capable of neutralizing the charge within the molecule. They may be anions in the form of a single atom or groups of atoms, or may be contained as substituents within the cationic dye. As set forth above, the cyanine dye cation denoted by general formula (D) can form a complex with a dye anion in the form of the azo metal complex dye.

From the perspective of the sensitizing effect, desirable examples of paired anions in addition to the azo metal complex dye (dye anion) are: halide ions, alkyl and aryl sulfonic acid ions, nitric acid ions, alkyl and arylcarboxylic acid ions, alkoxide ions, hexafluorophosphate ions, tetrafluoroborate ions, and perchloric acid ions. Preferred examples are chloride ions, bromide ions, iodide ions, and alkyl and arylsulfonic acid ions. An example of greater preference is p-toluenesulfonic acid ions.

When the azo metal complex dye is present in a mixed state with, that is, does not form a salt with, a cyanine dye, the blending ratio of the azo metal complex dye and the cationic dye in the recording layer is, based on weight, desirably azo metal complex dye: cyanine dye=95:5 to 50:50. When this weight ratio is greater than or equal to 95:5, the cyanine dye can effectively exert a sensitizing effect. At less than or equal to 50:50, it is possible to maintain the good properties of the azo metal complex dye in the recording layer. This weight ratio is preferably 95:5 to 80:20, and more preferably 95:5 to 90:10. When employed in combination with a cyanine dye, the content of the azo metal complex dye in the recording layer falls, for example, relative to the total weight of the recording layer, within a range of 50 to 95 weight percent, desirably within a range of 60 to 95 weight percent, preferably within a range of 70 to 95 weight percent, and optimally, within a range of 80 to 95 weight percent.

When the azo metal complex dye and the cyanine dye are present in a state in which they form a complex salt, the content of the complex salt in the recording layer falls, for example, relative to the total weight of the recording layer, within a range of 1 to 100 weight percent, desirably within a range of 70 to 100 weight percent, preferably within a range of 80 to 100 weight percent, and optimally, within a range of 90 to 100 weight percent.

To cause the azo metal complex dye and cyanine dye to be present in the recording layer in a state in which they form a complex salt, it is desirable to mix the azo metal complex dye and the cationic dye and collect the paired salt in advance as a solid, and then use the solid to prepare the recording layer. Since the excess salt can be removed by forming a complex salt of azo metal complex dye and cyanine dye, a recording layer affording even better recording characteristics can be obtained. It suffices for the complex salt to comprise structural components in the form of the azo metal complex dye and the cyanine dye; other components, such as ligands, can be contained together with the azo metal complex dye and the cyanine dye.

Specific examples of the cyanine dye cation constituting the complex salt are above-described (Cat-1) to (Cat-10). Specific examples of the azo metal complex dye anion are (An-1) to (An-8) below. However, the present invention is not limited to these specific examples.

Specific Examples of the Azo Metal Complex Dye Anion

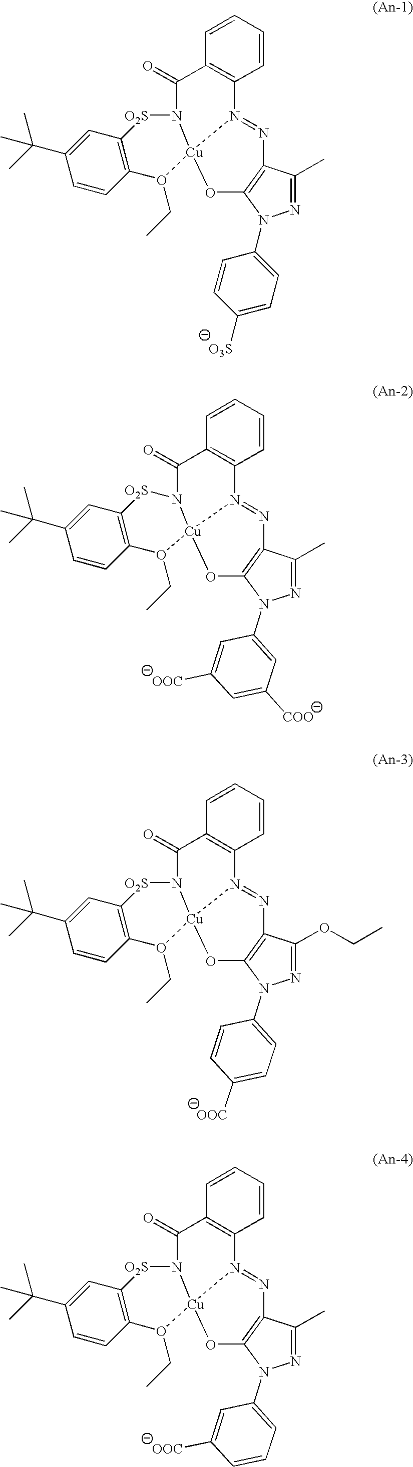

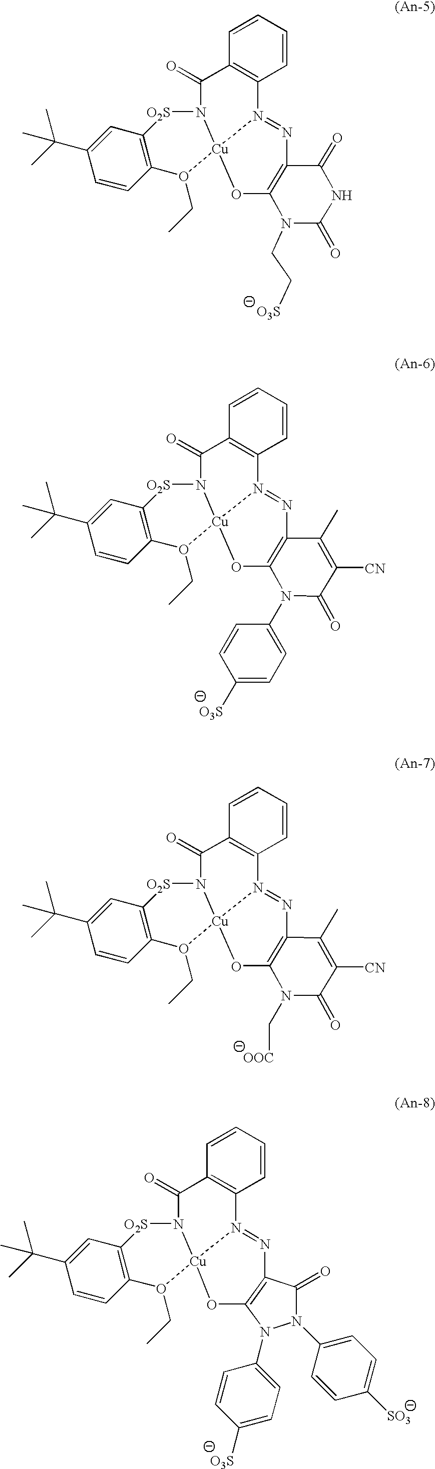

The optical information recording medium of the present invention comprise at least one layer of a recording layer containing the above-described azo metal complex dye on a support (desirably on a surface having pregrooves with a track pitch of 50 to 500 nm). It may also comprise two or more such recording layers. It may also comprise one or more recording layers in addition to a recording layer containing the azo metal complex dye. When other dyes are employed in combination as recording dyes in the recording layer containing the azo metal complex dye, the ratio of the azo metal complex dye to the total dye component is desirably 70 to 100 weight percent, preferably 80 to 100 weight percent.

In the present invention, when employing a dye in addition to the azo metal oxide dye and cyanine dye as a dye component in the recording layer, the dye desirably absorbs light in a short wavelength region, such as at a wavelength of equal to or shorter than 440 nm. Such dyes are not specifically limited. Examples are azo dyes, azo metal complex dyes, phthalocyanine dyes, oxonol dyes, cyanine dyes, and squalium dyes.

In the optical information recording medium of the present invention, the recording layer comprising the azo metal complex dye is a layer permitting the recording of information by irradiation of a laser beam. The phrase “permitting the recording of information by irradiation of a laser beam” means that the optical characteristics of portions of the recording layer that are irradiated with a laser beam change. The change in optical characteristics is thought to occur when a laser beam is directed onto the recording layer and the irradiated portions absorb the beam, causing the temperature to rise locally and producing a physical or chemical change (such as generating a pit). Reading (reproduction) of information that has been recorded on the recording layer can be achieved by irradiating a laser beam of the same wavelength as that employed in recording, for example, and detecting the difference in optical characteristics, such as the refractive index, between portions where the optical characteristics of the recording layer have been changed (recorded portions) and portions where they have not (unrecorded portions). The above-described azo metal complex dye absorbs laser beams of equal to or shorter than 440 nm, for example. The optical information recording medium of the present invention, which comprises a recording layer comprising the metal complex compound having absorption in the short wavelength region in this manner is suitable as a large-capacity optical disk permitting recording by a short-wavelength laser, such as an optical disk of the Blu-ray type that employs a blue laser of 405 nm. The method for recording information on the optical information recording medium of the present invention will be described further below.

The optical information recording medium of the present invention comprises at least the above-described recording layer comprising the azo metal complex dye on a support, and may further comprise a light reflective layer, a protective layer, and the like in addition to the above-described recording layer.

Any of the various materials conventionally employed as support materials for optical information recording media may be selected for use as the support employed in the present invention. A transparent disk-shaped support is preferably employed as the support.

Specific examples are glass, acrylic resins such as polycarbonate and polymethyl methacrylate, vinyl chloride resins such as polyvinyl chloride and vinyl chloride copolymers, epoxy resins, amorphous polyolefins, polyesters, and metals such as aluminum. They may be employed in combination as desired.

Of the above materials, thermoplastic resins such as amorphous polyolefins and polycarbonates are preferable, and polycarbonates are particularly preferable, from the perspectives of resistance to humidity, dimensional stability, low cost, and the like. When employing these resins, the support can be manufactured by injection molding.

The thickness of the support generally falls within a range of 0.7 to 2 mm, preferably a range of 0.9 to 1.6 mm, and more preferably, within a range of 1.0 to 1.3 mm.

To enhance smoothness and increase adhesive strength, an undercoating layer can be formed on the surface of the support on the side on which the light reflective layer, described further below, is positioned.

Tracking guide grooves or irregularities (pregrooves) denoting information such as address signals are formed on the surface of the support on which the recording layer is formed. The track pitch of these pregrooves desirably falls within a range of 50 to 500 nm. When the track pitch is equal to or greater than 50 nm, not only is it possible to correctly form the pregrooves, but the generation of crosstalk can be avoided. At equal to or less than 500 nm, high-density recording is possible. A support on which a narrower track pitch than that employed in CD-Rs and DVD-Rs is formed to achieve a higher recording density is desirably employed in the optical information recording medium of the present invention. The preferable range of the track pitch will be described in detail further below.

An optical information recording medium (referred to as “Embodiment (1)” hereinafter) sequentially comprising, from the support side, a support 0.7 to 2 mm in thickness, a dye-containing recordable recording layer, and a cover layer 0.01 to 0.5 mm in thickness is an example of a preferable embodiment of the optical information recording medium of the present invention.

In Embodiment (1), it is preferable for the pregrooves formed on the support to be 50 to 500 nm in the track pitch, 25 to 250 nm in the groove width, and 5 to 150 nm in the groove depth.

Optical information recording medium of Embodiment (1) will be described in detail below. However, the present invention is not limited to Embodiment (1).

### Optical Information Recording Medium of Embodiment (1)

The optical information recording medium of Embodiment (1) comprises at least a support, a recordable recording layer, and a cover layer. The optical information recording medium of Embodiment (1) is suitable as a Blu-ray type recording medium. In the Blu-ray system, information is recorded and reproduced by irradiation of a laser beam from the cover layer side, and a light reflective layer is normally provided between the support and the recording layer. Therefore, the laser beam is irradiated onto the recording layer from an opposite surface side, the opposite surface being opposite from the surface facing the reflective layer.

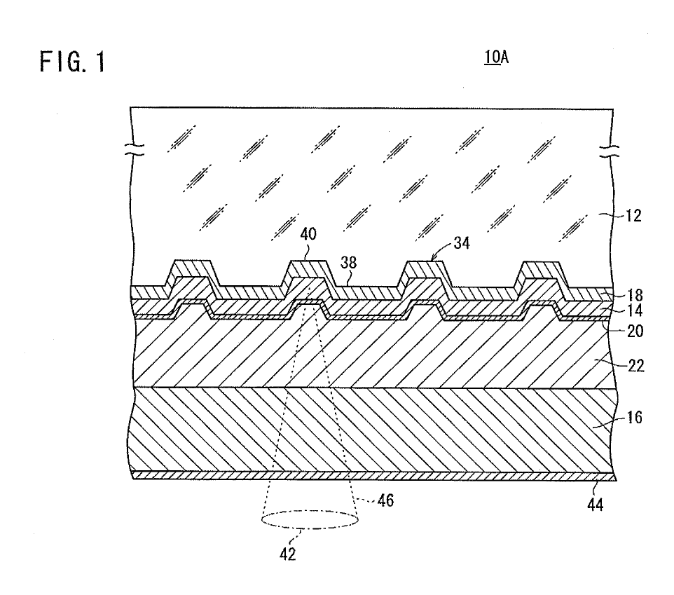

FIG. 1 shows an example of an optical information recording medium of Embodiment (1). The first optical information recording medium 10A shown in FIG. 1 is comprised of first light reflective layer 18, first recordable layer 14, barrier layer 20, first bonding layer or first adhesive layer 22, and cover layer 16, in that order on first support 12

These materials constituting these components will be sequentially described below.

### Support

On the support of Embodiment (1) are formed pregrooves (guide grooves) having a shape such that the track pitch, groove width (half width), groove depth, and wobble amplitude all fall within the ranges given below. The pregrooves are provided to achieve a recording density greater than that of CD-Rs and DVD-Rs. For example, the optical information recording medium of the present invention is suited to use as a medium for blue-violet lasers.

The track pitch of the pregrooves ranges from 50 to 500 nm. When the track pitch is equal to or greater than 50 nm, not only is it possible to correctly form the pregrooves, but the generation of crosstalk can be avoided. At equal to or less than 500 nm, high-density recording is possible. The rack pitch of the pregrooves is preferably ranges from 100 nm to 420 nm, more preferably from 200 nm to 370 nm, and further preferably from 260 nm to 330 nm.

The groove width (half width) of the pregrooves ranges from 25 to 250 mm, preferably from 50 to 240 mm, more preferably from 80 to 230 nm, and further preferably from 100 to 220 nm. A pregroove width of equal to or higher than 25 nm can permit adequate transfer of the grooves during molding and can inhibit a rise in the error rate during recording. A groove width of equal to or lower than 250 nm can also permit adequate transfer of grooves during molding and can avoid crosstalk due to the widening of bits formed during recording.

The groove depth of the pregrooves ranges from 5 to 150 nm. Pregrooves that are equal to or greater 5 nm in depth can permit an adequate degree of recording modulation, and a depth of equal to or less than 150 nm can permit the achieving of high reflectance. The groove depth of the pregrooves preferably ranges from 10 to 85 nm, more preferably from 20 to 80 nm, and further preferably from 28 to 75 nm.

The upper limit of the groove tilt angle of the pregrooves is preferably equal to or less than 80°, more preferably equal to or less than 75°, further preferably equal to or less than 70°, and still more preferably, equal to or less than 65°. The lower limit is preferably equal to or greater than 20°, more preferably equal to or greater than 30°, and still more preferably, equal to or greater than 40°.

When the groove tilt angle of the pregrooves is equal to or greater than 20°, an adequate tracking error signal amplitude can be achieved, and at equal to or less than 80°, shaping properties are good.

### Recordable Recording Layer

The recordable recording layer of Embodiment (1) can be formed by preparing a coating liquid by dissolving the dye in a suitable solvent with or without the use of a binder or the like, coating this coating liquid on the support or on a light reflective layer, described further below, to form a coating, and then drying the coating. The recordable recording layer may comprise a single layer or multiple layers. When the structure is multilayer, the step of coating the coating liquid may be conducted multiple times.

The concentration of dye in the coating liquid generally ranges from 0.01 to 15 weight percent, preferably ranges from 0.1 to 10 weight percent, more preferably ranges from 0.5 to 5 weight percent, and still more preferably, ranges from 0.5 to 3 weight percent.

Examples of the solvent employed in preparing the coating liquid are: esters such as butyl acetate, ethyl lactate, and Cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, isopropanol, and n-butanol diacetone alcohol; fluorine solvents such as 2,2,3,3-tetrafluoro-1-propanol; and glycol ethers such as ethylene glycol monomethylether, ethylene glycol monoethylether, and propylene glycol monomethylether.

The solvents may be employed singly or in combinations of two or more in consideration of the solubility of the dyes employed. Binders, oxidation inhibitors, UV absorbing agents, plasticizers, lubricants, and various other additives may be added to the coating liquid as needed.

Examples of coating methods are spraying, spincoating, dipping, roll coating, blade coating, doctor roll coating, and screen printing.

During coating, the temperature of the coating liquid preferably falls within a range of 23 to 50° C., more preferably within a range of 24 to 40° C., and further preferably, within a range of 23 to 50° C.

The thickness of the recordable recording layer on lands (protrusions on the support) is preferably equal to or less than 300 nm, more preferably equal to or less than 250 nm, further preferably equal to or less than 200 nm, and still more preferably, equal to or less than 180 nm. The lower limit is preferably equal to or greater than 1 nm, more preferably equal to or greater than 3 nm, further preferably equal to or greater than 5 nm, and still more preferably, equal to or greater than 7 nm.

The thickness of the recordable recording layer on grooves (indentation in the support) is preferably equal to or less than 400 nm, more preferably equal to or less than 300 nm, and further preferably, equal to or less than 250 nm. The lower limit is preferably equal to or greater than 10 nm, more preferably equal to or greater than 20 nm, and further preferably, equal to or greater than 25 nm.

The ratio of the thickness of the recordable recording layer on lands to the thickness of the recordable recording layer on grooves (thickness on lands/thickness on grooves) is preferably equal to or greater than 1.0, more preferably equal to or greater than 0.13, further preferably equal to or greater than 0.15, and still more preferably, equal to or greater than 0.17. The upper limit is preferably less than 1, more preferably equal to or less than 0.9, further preferably equal to or less than 0.85. and still more preferably, equal to or less than 0.8.

Various antifading agents may be incorporated into the recordable recording layer to enhance the resistance to light of the recordable recording layer. Singlet oxygen quenchers are normally employed as the antifading agent. The single oxygen quencher can also be employed in the present invention to further enhance the resistance to light. Singlet oxygen quenchers that are described in known publications such as patent specifications may be employed.

Specific examples are described in Japanese Unexamined Patent Publication (KOKAI) Showa Nos. 58-175693, 59-81194, 60-18387, 60-19586, 60-19587, 60-35054, 60-36190, 60-36191, 60-44554, 60-44555, 60-44389, 60-44390, 60-54892, 60-47069, and 63-209995; Japanese Unexamined Patent Publication (KOKAI) Heisei No. 4-25492; Japanese Examined Patent Publication (KOKOKU) Heisei Nos. 1-38680 and 6-26028; German Patent No. 350399; and the Journal of the Japanese Chemical Society, October Issue, 1992, p. 1141, which are expressly incorporated herein by reference in their entirety.

The quantity of antifading agent in the form of the above singlet oxygen quencher or the like normally falls within a range of 0.1 to 50 weight percent, preferably falls within a range of 0.5 to 45 weight percent, more preferably falls within a range of 3 to 40 weight percent, and still more preferably, falls within a range of 5 to 25 weight percent, of the quantity of dye.

### Cover Layer

The cover layer in Embodiment (1) is normally adhered through a bonding agent or adhesive onto the above-described recordable recording layer or onto a barrier layer such as that shown in FIG. 1.

The cover layer is not specifically limited, other than that it be a film of transparent material. An acrylic resin such as a polycarbonate or polymethyl methacrylate; a vinyl chloride resin such as polyvinyl chloride or a vinyl chloride copolymer; an epoxy resin; amorphous polyolefin; polyester; or cellulose triacetate is preferably employed. Of these, the use of polycarbonate or cellulose triacetate is more preferable.

The term “transparent” means having a transmittance of equal to or greater than 80 percent for the beam used in recording and reproducing.

The cover layer may further contain various additives so long as they do not compromise the effect of the present invention. For example, UV-absorbing agents may be incorporated to cut light with the wavelength of equal to or shorter than 400 nm and/or dyes may be incorporated to cut light with the wavelength of equal to or longer than 500 nm.

As for the physical surface properties of the cover layer, both the two-dimensional roughness parameter and three-dimensional roughness parameter are preferably equal to or less than 5 nm.

From the perspective of the degree of convergence of the beam employed in recording and reproducing, the birefringence of the cover layer is preferably equal to or lower than 10 nm.

The thickness of the cover layer can be suitably determined based on the NA or wavelength of the laser beam irradiated in recording and reproducing. In the present invention, the thickness preferably falls within a range of 0.01 to 0.5 mm, more preferably a range of 0.05 to 0.12 mm.

The total thickness of the cover layer and bonding or adhesive layer is preferably 0.09 to 0.11 mm, more preferably 0.095 to 0.105 mm.

A protective layer (hard coating layer 44 in the embodiment shown in FIG. 1) may be provided on the incident light surface of the cover layer during manufacturing of the optical information recording medium to prevent scratching of the incident light surface.

To bond the cover layer and the recordable recording layer or barrier layer, a bonding layer or an adhesive layer may be provided between the two layers.

A UV-curable resin, EB-curable resin, thermosetting resin, or the like is preferably employed as the bond in the bonding layer.

When employing a UV-curable resin as the bond, the UV-curable resin may be employed as is, or dissolved in a suitable solvent such as methyl ethyl ketone or ethyl acetate to prepare a coating liquid, which is then coated on the surface of the barrier layer with a dispenser. To prevent warping of the optical information recording medium that has been manufactured, a UV-curable resin having a low curing shrinkage rate is preferably employed in the bonding layer. Examples of such UV-curable resins are SD-640 and the like, made by Dainippon Ink and Chemicals, Inc.

The method of forming the bonding layer is not specifically limited. It is desirable to coat a prescribed quantity of bond on the surface of the barrier layer or the recordable layer (the bonded surface), dispose a cover layer thereover, uniformly spread the bond between the bonded surface and the cover layer by spin-coating or the like, and then cure the bond.

The thickness of the bonding layer preferably falls within a range of 0.1 to 100 micrometers, more preferably a range of 0.5 to 50 micrometers, and further preferably, 1 to 30 micrometers.

Examples of the adhesive employed in the adhesive layer are acrylic, rubber, and silicone adhesives. From the perspectives of transparency and durability, acrylic adhesives are preferable. Preferable acrylic adhesive is an acrylic adhesive comprising a main component in the form of 2-ethylhexyl acrylate, n-butyl acrylate, or the like copolymerized with a short-chain alkyl acrylate or methacrylate, such as methyl acrylate, ethyl acrylate, or methyl methacrylate to increase the cohesive force, and the component capable of becoming a crosslinking point with a crosslinking agent, such as acrylic acid, methacrylic acid, an acrylamide derivative, maleic acid, hydroxylethyl acrylate, or glycidyl acrylate. The type and blending ratio of the main component, short-chain component, and component for the addition of a crosslinking point can be suitably adjusted to vary the glass transition temperature (Tg) and crosslinking density. The glass transition temperature (Tg) preferably equal to or less than 0° C., more preferably equal to or less than −15° C., and further preferably, equal to or less than −25° C.

The glass transition temperature (Tg) can be measured by differential scanning calorimetry (DSC) with a DSC6200R made by Seiko Instruments, Inc.

The method described in Japanese Unexamined Patent Publication (KOKAI) No. 2003-217177, Japanese Unexamined Patent Publication (KOKAI) No. 2003-203387, Japanese Unexamined Patent Publication (KOKAI) Heisei No. 9-147418, which are expressly incorporated herein by reference in their entirety, or the like can be used to prepare the adhesive.

The method of forming the adhesive layer is not specifically limited. A prescribed quantity of adhesive can be uniformly coated on the surface of the barrier layer or recordable recording layer (the adhered surface), a cover layer can be disposed thereover, and the adhesive can be cured. Alternatively, a prescribed quantity of adhesive can be uniformly coated on one side of the cover layer to form a coating of adhesive, this coating can be adhered to the adhered surface, and then the adhesive can be cured.

Further, a commercial adhesive film on which an adhesive layer has been disposed in advance can be employed as the cover layer.

The thickness of the adhesive layer preferably falls within a range of 0.1 to 100 micrometers, more preferably a range of 0.5 to 50 micrometers, and further preferably, a range of 10 to 30 micrometers.

The cover layer can also be formed by spin-coating UV-curable resin.

### Other Layers

The optical information recording medium of Embodiment (1) may optionally comprise other layers in addition to the above-described essential layers so long as the effect of the present invention is not compromised. Examples of such optional layers are a label layer having a desired image that is formed on the back of the support (the reverse unformed side from the side on which the recordable recording layer is formed), a light reflective layer positioned between the support and the recordable recording layer (described in detail further below), a barrier layer positioned between the recordable recording layer and the cover layer (described in detail further below), and a boundary layer positioned between the above light reflective layer and the recordable recording layer. The “label layer” may be formed from UV-curing resin, thermosetting resin, or heat-drying resin.

Each of the above-described essential layers and optional layers may have a single-layer or multilayer structure.

To increase reflectance for the laser beam and impart functions that enhance recording and reproducing characteristics to the optical information recording medium of Embodiment (1), a light reflective layer is preferably formed between the support and the recordable recording layer.

The reflective layer can be formed, for example, by vacuum vapor depositing, by sputtering, or by ion plating a light reflective substance with high reflectance for the laser beam on the support. The thickness of the light reflective layer can normally range from 10 to 300 nm, preferably ranges from 30 to 200 nm.

The reflectance is preferably equal to or greater than 70 percent.

Examples of light reflective substances of high reflectance are: metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi; and stainless steel. These light reflective substances may be employed singly, in combinations of two or more, or as alloys. Of these, the preferable substances are: Cr, Ni, Pt, Cu, Ag, Au, Al, and stainless steel; the more preferable substances are: Au, Ag, Al, and their alloys; and the substances of greatest preference are: Au, Ag, and their alloys.

### Barrier Layer

In the optical information recording medium of Embodiment (1), as shown in FIG. 1, it is preferable to form a barrier layer between the recordable recording layer and the cover layer.

The barrier layer can be provided to enhance the storage properties of the recordable recording layer, enhance adhesion between the recordable recording layer and cover layer, adjust the reflectance, adjust thermal conductivity, and the like.

The material employed in the barrier layer is a material that passes the beam employed in recording and reproducing; it is not specifically limited beyond being able to perform this function. For example, it is generally desirable to employ a material with low permeability to gas and moisture. A material that is also a dielectric is preferred.

Specifically, materials in the form of nitrides, oxides, carbides, and sulfides of Zn, Si, Ti, Te, Sn, Mo, Ge, Nb, Ta and the like are preferable. MoO₂, GeO₂, TeO, SiO₂, TiO₂, ZuO, SnO₂, ZnO—Ga₂O₃, Nb₂O₅, and Ta₂O₅ are preferable and SnO₂, ZnO—Ga₂O₃, SiO₂, Nb₂O₅, and Ta₂O₅ are more preferable.

The barrier layer can be formed by vacuum film-forming methods such as vacuum vapor deposition, DC sputtering, RF sputtering, and ion plating. Of these, sputtering is preferred.

The thickness of the barrier layer preferably falls within a range of 1 to 200 nm, more preferably within a range of 2 to 100 nm, and further preferably, within a range of 3 to 50 nm.

### Method of Recording Information

The present invention relates to a method of recording information on the recording layer comprised in the optical information recording medium of the present invention by irradiation of a laser beam having a wavelength of equal to or shorter than 440 nm onto the optical information recording medium.

By way of example, information is recorded on the above-described preferred optical information recording medium of Embodiment (1) in the following manner.

First, while rotating an optical information recording medium at a certain linear speed (such as 0.5 to 10 m/s) or a certain angular speed, a laser beam for recording, such as a semiconductor laser beam, is directed from the protective layer side. Irradiation by this laser beam changes the optical properties of the portions that are irradiated, thereby recording information. In the embodiment shown in FIG. 1, recording laser beam 46 such as a semiconductor laser beam is directed from cover layer 16 side through first object lens 42 (having a numerical aperture NA of 0.85, for example). Irradiation by laser beam 46 causes recordable recording layer 14 to absorb laser beam 46, resulting in a local rise in temperature. This is thought to produce a physical or chemical change (such as generating pits), thereby altering the optical characteristics and recording information.

In the method of recording information of the present invention, information is recorded by irradiation of a laser beam having a wavelength of equal to or shorter than 440 nm. A semiconductor laser beam having an oscillation wavelength falling within a range of equal to or shorter than 440 nm is suitable for use as a recording beam. A blue-violet semiconductor laser beam having an oscillation wavelength falling within a range of 390 to 415 nm and a blue-violet SHG laser beam having a core oscillation wavelength of 425 nm obtained by halving the wavelength of an infrared semiconductor laser beam having a core oscillation wavelength of 850 nm with an optical waveguide device are examples of preferable light sources. In particular, a blue-violet semiconductor laser beam having an oscillation wavelength of 390 to 415 nm is preferably employed from the perspective of recording density. The information that is thus recorded can be reproduced by directing the semiconductor laser beam from the support side or protective layer side while rotating the optical information recording medium at the same constant linear speed as in the recording, and detecting the reflected beam.

### Azo Metal Complex Dye and Azo Metal Complex Salt Dye

The present invention further relates to:

an azo metal complex dye denoted by general formula (4), (5), (6-1) or (6-2); and

an azo metal complex salt dye of a cyanine dye cation denoted by general formula (D) and an azo metal complex dye denoted by general formula (4), (5), (6-1) or (6-2).

The azo metal complex dye and azo metal complex salt dye of the present invention can be employed in various uses, such as colorants, photographic materials, UV-absorbing materials, color filter dyes, and color-changing filters. The azo metal complex dye and azo metal complex salt dye of the present invention can afford good characteristics in optical information recording, particularly recording by irradiation with a short-wavelength laser beam. They also can afford good light resistance and storage stability in solution. Thus, they are desirably employed as a recording layer dye in an optical information recording medium having a dye-containing recording layer. The details of the azo metal complex dye and azo metal complex salt dye of the present invention, and methods for manufacturing them, are as set forth above.

### EXAMPLES

The present invention will be described in detail below based on examples. However, the present invention is not limited to the examples.

Specific examples of methods of synthesizing the azo metal complex dyes denoted by general formulas (1) and (4) will be described below. However, the present invention is not limited to these methods.

### Synthesis of Compound (A-1)

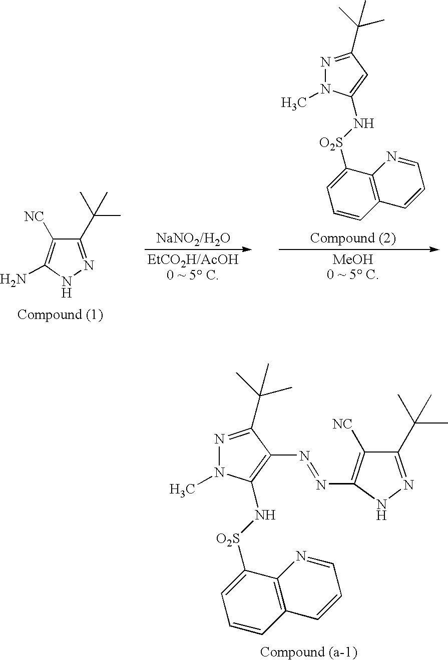

To a 100 mL triangular flask were charged 1 mL of acetic acid and 2 mL of propionic acid, after which 1.4 mL of hydrochloric acid (35 to 37 percent) was gradually added dropwise with ice cooling. The mixture was cooled to 0 to 5° C. in an ice bath. A 1 mL quantity of an aqueous solution in which 0.31 g of NaNO₂ was dissolved was gradually added dropwise, after which the mixture was stirred for one hour at 0 to 5° C. This acid solution was gradually added to 20 mL of methanol solution containing 1.55 g of compound (2) maintained at 0 to 5° C. by ice cooling, and then stirred for 1 hour. The mixture was restored to room temperature and stirred for 2 hours, after which 200 mL of distilled water was added. The mixture was then extracted with ethyl acetate. The solvent was distilled off, and silica gel column chromatography was conducted using ethyl acetate/hexane 1:1 as eluant, yielding 1.27 g of compound (a-1).

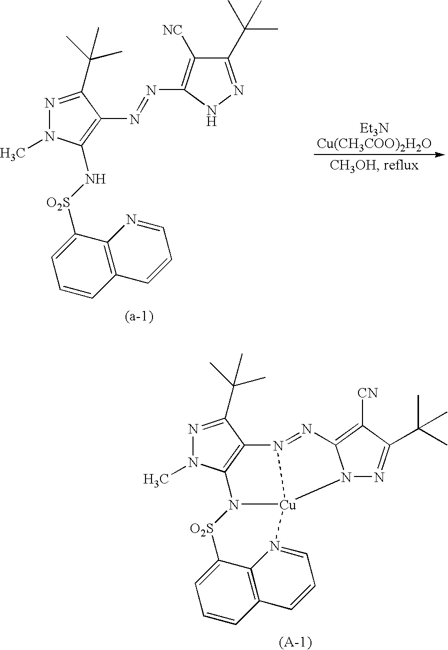

To a 50 mL eggplant-shaped flask were charged 0.75 g of compound (a-1) and 10 mL of methanol. A 0.41 mL quantity of triethylamine was added dropwise while stirring. The mixture was stirred for 10 minutes, 300 mg of Cu(OAc)₂.H₂O was added, and the mixture was hot refluxed for 2 hours. The precipitate was separated by filtration, washed with methanol, and dried, yielding 230 mg of compound (A-1). The compound was identified by MALDI-MS.

m/z=581 (posi)

(A-3), (A-4), (A-5), (A-6), (A-9), (A-10), (A-12), (B-1), (B-2), and (B-9) were synthesized by the same method as that used to synthesize compound (A-1). The compounds were identified by MALDI-MS.

The azo metal complex dyes denoted by general formulas (3-1) and (6-1) can be synthesized by the methods described in Japanese Unexamined Patent Publication (KOKAI) Nos. 2001-335712, 2002-129046, which are expressly incorporated herein by reference in their entirety, and the like. Specific examples are given below. However, the present invention is not limited to these methods.

### Synthesis of Compound (C-1)

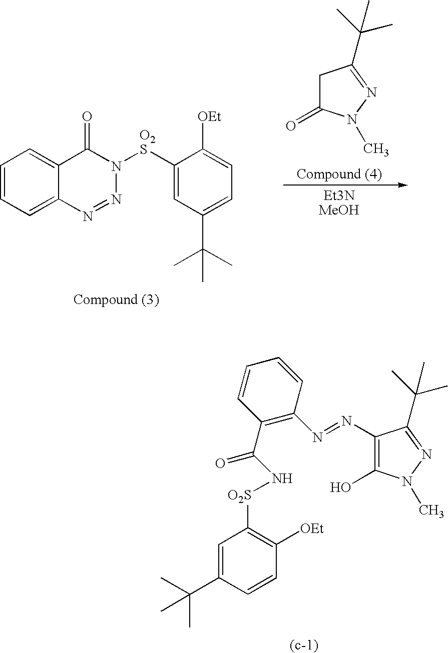

To a three-necked, 100 mL flask were charged 1.5 g of compound (3) and 40 mL of methanol. A 0.43 mL quantity of triethylamine was added while stirring. Separation processing was conducted with ethyl acetate/distilled water, and the ethyl acetate was distilled off under reduced pressure. The solid obtained was recrystallized with ethyl acetate/hexane, yielding 2.04 g of compound (c-1).

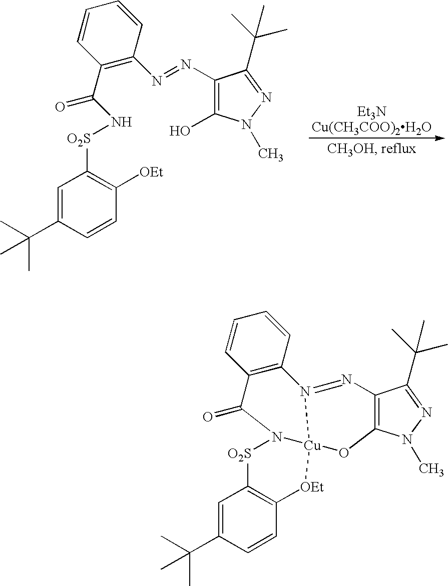

To a 50 mL eggplant-shaped flask were charged 0.6 g of compound (c-1) and 8 mL of methanol. A 0.25 mL quantity of triethylamine was added while stirring, and 0.22 g of copper acetate monohydrate was added. The mixture was hot refluxed for 2 hours. The reaction solution was then poured into 50 mL of distilled water with stirring. The precipitate obtained was dried by heating, yielding 0.57 g of compound (C-1). The compound was identified by MALDI-MS.

m/z=601 (nega)

The azo metal complex dyes denoted by general formulas (3-2) and (6-2) can be synthesized by the same methods as the azo metal complex dyes denoted by general formulas (3-1) and (6-1).

Compounds (C-2), (C-4), (C-5), (C-9), (C-10), (C-11), (C-12), (C-13), (D-1), (D-4), and (D-5) were synthesized by the same method as compound (C-1). The various azo metal complex dyes described in the present invention can be synthesized by the same method.

### Examples 1 to 23

### Preparation of Optical Information Recording Medium

### (Preparation of Support)

An injection molded support comprised of polycarbonate resin and having a thickness of 1.1 mm, an outer diameter of 120 mm, an inner diameter of 15 mm, and spiral pregrooves (with a track pitch of 320 nm, a groove width (at concave portion) of 190 nm, a groove depth of 47 nm, a groove tilt angle of 65°, and a wobble amplitude of 20 nm) was prepared. Mastering of the stamper employed during injection-molding was conducted by laser beam (351 nm) cutting.

### (Formation of Light Reflective Layer)

An ANC (Ag: 98.1 at %, Nd: 0.7 at %, Cu: 0.9 at %) light reflective layer 60 nm in thickness was formed on the support as a vacuum-formed film layer by DC sputtering in an Ar atmosphere using a Cube manufactured by Unaxis Corp. The thickness of the light reflective film was adjusted by means of the duration of sputtering.

### (Formation of Recordable Recording Layer)

A one gram of each of compounds (A-1), (A-3), (A-4), (A-5), (A-6), (A-9), (A-10), (A-12), (B-1), (B-2), (B-9), (C-1), (C-2), (C-4), (C-5), (C-9), (C-10), (C-11), (C-12), (C-13), (D-1), (D-4), and (D-5) was separately added to and dissolved in 100 mL of 2,2,3,3-tetrafluoropropanol and dye-containing coating liquids were prepared as Examples 1 to 23. The dye-containing coating liquids that had been prepared were then coated on a first reflective layer 18 by spin coating while varying the rotational speed from 500 to 2,200 rpm under conditions of 23° C. and 50 percent RH to form a first recordable recording layer 14.

After forming the recordable recording layer, annealing was conducted in a clean oven. In the annealing process, the supports were supported while creating a gap with spacers in the vertical stack pole and maintained for 1 hour at 80° C.

### (Formation of Barrier Layer)

Subsequently, a Cube made by Unaxis Corp. was employed to form by DC sputtering in an argon atmosphere a barrier layer comprised of Nb₂O₅ having a thickness of 10 nm on the recordable recording layer.

### (Adhesion of a Cover Layer)

A cover layer in the form of a polycarbonate film (Teijin Pureace, 80 micrometers in thickness) measuring 15 mm in inner diameter, 120 mm in outer diameter, and having an adhesive layer (with a glass transition temperature of −52° C.) on one side was provided so that the combined thickness of the adhesive layer and the polycarbonate film was 100 micrometers.

After placing the cover layer on the barrier layer through the adhesive layer, a member was placed against the cover layer and pressure was applied, bonding the cover layer and barrier layer. This process yielded an optical information recording medium having the layer structure shown in FIG. 1.

The optical information recording media of Examples 1 to 23 were thus prepared.

### <Measurement of the Film Thickness of the Dye Layer>

Cross-sections of the optical information recording media obtained were viewed by SEM and the thickness of the dye layer respectively at the groove concave portion and the groove convex portion were read. The groove concave portion of the dye layer was about 40 nm in thickness, and the groove convex portion of the dye layer was about 15 nm in thickness.

### Comparative Examples 1 to 4

### Preparation of Optical Information Recording Medium

With the exception that comparative compounds (A) to (D) were employed in place of the exemplified compound as dyes in the recordable recording layer, the optical information recording media of Comparative Examples 1 to 4 were prepared by the same method as in Examples.

Comparative compound (A): compound described in Japanese Unexamined Patent Publication (KOKAI) No. 2001-158862

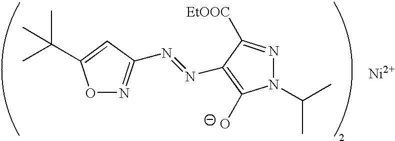

Comparative compound (B): compound described in Japanese Unexamined Patent Publication (KOKAI) No. 2001-158862

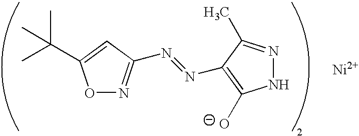

Comparative compound (C): compound described in Japanese Unexamined Patent Publication (KOKAI) No. 2006-306070

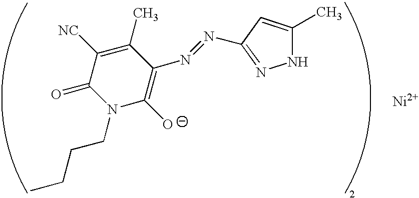

Comparative compound (D): compound described in Japanese Unexamined Patent Publication (KOKAI) No. 2007-26541

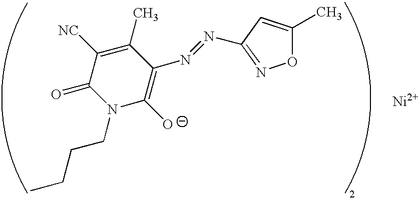

### <Evaluation of Optical Information Recording Media>

### 1. Evaluation of C/N (Carrier/Noise Ratio)

A 0.16 micrometer signal (2T) was recorded on and reproduced from the prepared optical information recording media at a clock frequency of 66 MHz and a linear speed of 4.92 m/s with an apparatus for evaluating recorded and reproduced information (DDU1000 made by Pulstech Corp.) equipped with a 403 nm laser and an NA 0.85 pickup, and the output was measured with a spectral analyzer (FSP-3 made by Rohde-Schwarz). Peak output observed in the vicinity of 16 MHz following recording was adopted as the carrier output, and the output at the same frequency before recording was adopted as the noise output. The output following recording minus the output prior to recording was taken as the C/N value. Recording was conducted on grooves. The laser beam for recording and reproduction was irradiated from the cover layer side. The recording power was 5 mW and the reproducing power was 0.3 mW. The results are shown in Table 1. The 2T C/N ratio serving as an index of the recording characteristics tended to increase with the recording power, but from the perspectives of the 2T C/N ratio and recording sensitivity, a C/N ratio (following recording) of equal to or greater than 35 dB at about 5 mW was considered adequate for both recording sensitivity and reproduction signal intensity, indicating good recording characteristics.

### 2. Evaluation of the Light Resistance of the Dye Film

Dye-containing coating liquids identical to Examples 1 to 23 and Comparative Examples 1 to 4 were prepared and applied at 23° C. and 50% RH to glass sheets 1.1 mm in thickness by spincoating while varying the rotational speed from 500 to 1,000 rpm. Subsequently, the glass sheets were maintained for 24 hours at 23° C. and 50% RH. A merry-go-round shaped light resistance tester (Cell Tester III, made by Eagle Engineering, Inc., with WG320 filter made by Schott) was then used to conduct a light resistance test. The absorption spectra of the dye film immediately prior to the light resistance test and 48 hours after the light resistance test were measured with a UV-1600PC (made by Shimadzu Corp.). The change in absorbance at the maximum absorption wavelength was read.

### 3. Evaluation of the Storage Stability of the Dye Solution

Diluted solutions (abs=0.9 to 1.1) of the azo metal complex dyes employed in Examples 1 to 23 and Comparative Examples 1 to 4 were prepared. The solutions were stored for 24 hours at 60° C., after which the λmax value of the solution absorption spectrum was read and the dye remaining rate was measured.

TABLE 1

| | | | Recording and | Dye remaining |
|---|---|---|---|---|
| | | Light | reproduction | rate after storage |
| | | resistance of | characteristics | for 24 hours in |
| | | dye | (2T recording | coating solution |
| | Azo dye | film^{(Note 1)} | C/N)^{(Note 2)} | at 60° C.^{(Note 3)} |
| Ex. 1 | (A-1) | ⊚ | ⊚ | ⊚ |
| Ex. 2 | (A-3) | ⊚ | ◯ | ⊚ |
| Ex. 3 | (A-4) | ⊚ | ◯ | ⊚ |
| Ex. 4 | (A-5) | ⊚ | ⊚ | ⊚ |
| Ex. 5 | (A-6) | ⊚ | ⊚ | ⊚ |
| Ex. 6 | (A-9) | ⊚ | ⊚ | ⊚ |
| Ex. 7 | (A-10) | ⊚ | ⊚ | ⊚ |
| Ex. 8 | (A-12) | ◯ | ⊚ | ⊚ |
| Ex. 9 | (B-1) | ⊚ | ◯ | ⊚ |
| Ex. 10 | (B-2) | ◯ | ◯ | ⊚ |
| Ex. 11 | (B-9) | ⊚ | ◯ | ⊚ |
| Ex. 12 | (C-1) | ⊚ | ◯ | ⊚ |
| Ex. 13 | (C-2) | ⊚ | ◯ | ⊚ |
| Ex. 14 | (C-5) | ⊚ | ⊚ | ⊚ |
| Ex. 15 | (C-6) | ⊚ | ⊚ | ⊚ |
| Ex. 16 | (C-9) | ⊚ | ⊚ | ⊚ |
| Ex. 17 | (C-10) | ⊚ | ⊚ | ⊚ |
| Ex. 18 | (C-11) | ⊚ | ⊚ | ⊚ |
| Ex. 19 | (C-12) | ⊚ | ⊚ | ⊚ |
| Ex. 20 | (C-13) | ⊚ | ⊚ | ⊚ |
| Ex. 21 | (D-1) | ⊚ | ◯ | ⊚ |
| Ex. 22 | (D-4) | ⊚ | ⊚ | ⊚ |
| Ex. 23 | (D-5) | ⊚ | ⊚ | ⊚ |
| Comp. | Comp. | ◯ | Δ | X |
| Ex. 1 | Compound | | | |
| | (A) | | | |
| Comp. | Comp. | X | X^{(Note 4)} | X |
| Ex. 2 | Compound | | | |
| | (B) | | | |
| Comp. | Comp. | — | X^{(Note 4)} | X |
| Ex. 3 | Compound | (Not | | |
| | (C) | dissolved) | | |
| Comp. | Comp. | X | ⊚ | X |
| Ex. 4 | Compound | | | |
| | (D) | | | |

^{(Note 1)}After 48 hours of irradiation by Xe lamp, a dye remaining rate at absorption λmax of equal to or greater than 90 percent was denoted by ⊚, equal to or greater than 85 percent but less than 90 percent by ◯, equal to or greater than 75 percent but less than 85 percent by Δ, and less than 75 percent by X.
^{(Note 2)}2T recording C/N of equal to or greater than 39 dB was denoted by ⊚, equal to or greater than 35 dB but less than 39 dB by ◯, equal to or greater than 30 dB but less than 35 dB by Δ, and less than 30 dB by X.
^{(Note 3)}Dye remaining rate of equal to or greater than 90 percent was denoted by ⊚, equal to or greater than 80 percent but less than 90 percent by ◯, equal to or greater than 70 percent but less than 80 percent by Δ; and less than 70 percent by X.
^{(Note 4)}Due to poor solubility and the inability to form an adequate recording layer, recording or measurement was precluded.

As shown in Table 1, in contrast to Comparative Examples 1 to 4, in which conventional azo metal complexes were employed, each of Examples 1 to 23 achieved both light resistance and recording and reproduction characteristics, and exhibited good characteristics as dyes for Blu-ray disks.

It was also confirmed that the azo metal complex dyes employed in Examples exhibited extremely good solubility in the coating solvent.

It was further confirmed that the azo metal complex dyes employed in Examples exhibited good solution stability in the coating solvent. Long-term storage in solution was determined to be possible.

### <Evaluation of the Light Resistance of the Dye Solution>

Each of the azo metal complex dyes employed in Examples was dissolved in 2,2,3,3-tetrafluoropropanol to an absorbance of 0.95 to 1.05 (cell width 1 cm), and light resistance was evaluated under the same conditions as in the evaluation of the light resistance of the dye films. As a result, each of the dye solutions exhibited an extremely high light resistance that was equivalent or better to that of the dye films. Light resistance is an important property that is required of dyes in a variety of applications. The compounds according to the present invention, with their good light resistance in both film and solution states, were found to exhibit desirable properties in a variety of applications, such as ink, color filters, color-changing filters, photographic materials, and thermal transfer recording materials.

Compounds (A-1), (A-3), (A-4), (A-5), (A-6), (A-9), (A-10), (A-12), (B-1), (B-2), (B-9), (C-1), (C-2), (C-4), (C-5), (C-9), (C-10), (C-11), (C-12), (C-13), (D-1), (D-4), and (D-5) neither decomposed nor melted at 150° C. in a powder state and in a film state, revealing that these compounds are excellent in thermal stability. Dyes with excellent thermal stability can exhibit desirable properties in a variety of applications, such as ink, color filters, color-changing filters, photographic materials, and conductive films.

### Example 24

### Synthesis of Complex Salt (M-1) of Cyanine Dye Cation and Azo Metal Complex Dye Anion

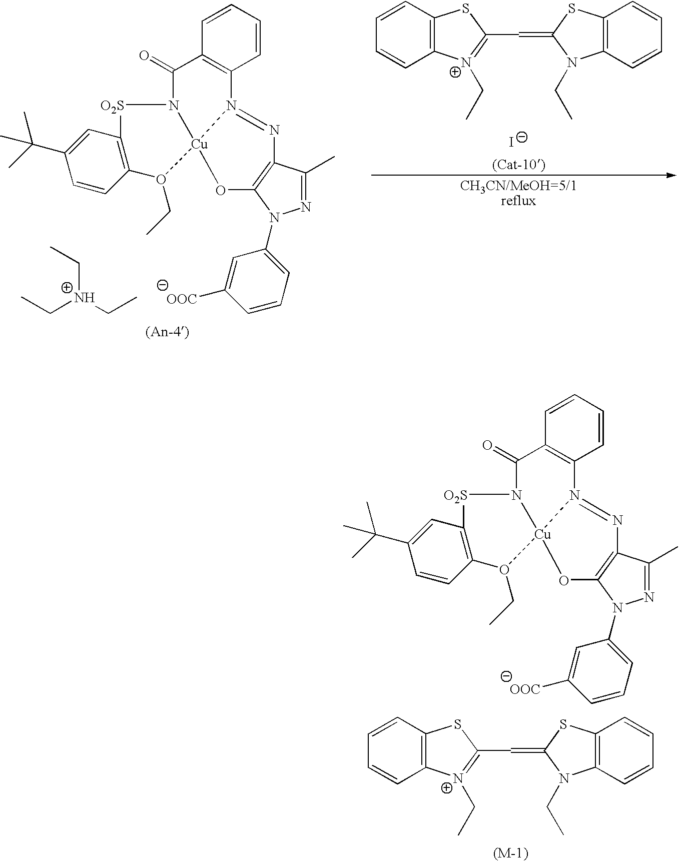

To a 50 mL eggplant-shaped flask were charged 24 mg of (Cat-10′) and 40 mg of (An-4′) synthesized by the same method as above-described (C-1). A 1 mL quantity of methanol and 5 mL of acetonitrile were then added. The reaction solution was hot refluxed for 2 hours. The precipitate obtained was separated by filtration and dried, yielding 30 mg of (M-1). The compound obtained was identified by MALDI-MS and HPLC. Removal of the triethylammonium contained in (An-4′) was confirmed by GC. Based on these identifications, the formation of a complex salt of an azo metal complex dye anion (An-4) and a cyanine dye cation (Cat-10) was confirmed.

### Example 25

### Synthesis of Complex Salt (M-2) of Cyanine Dye Cation and Azo Metal Complex Dye Anion

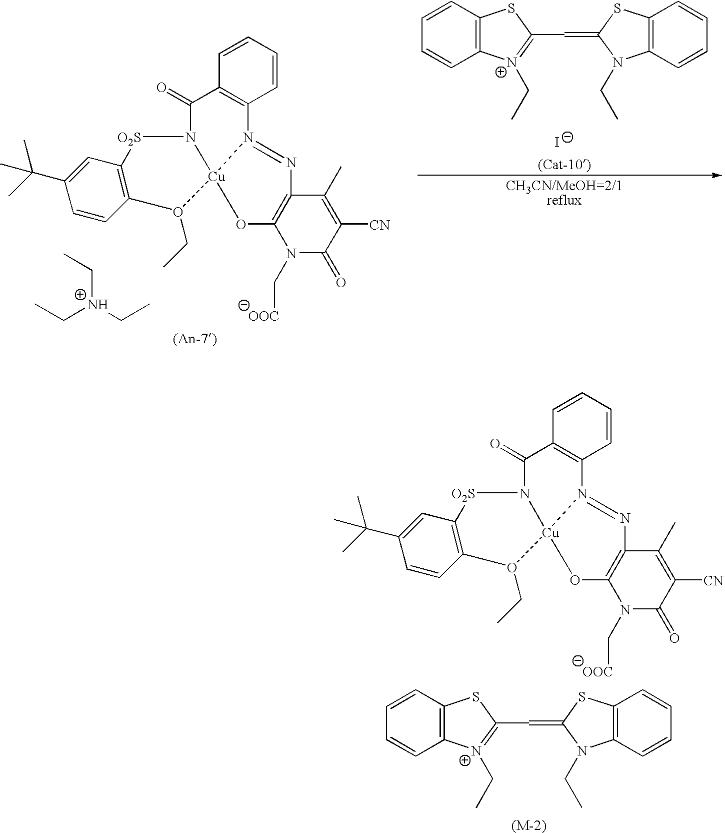

To a 50 mL eggplant-shaped flask were charged 123 mg of (Cat-10′) and 200 mg of (An-7′) synthesized by the same method as above-described (C-1). A 1 mL quantity of methanol and 2 mL of acetonitrile were then added. The reaction solution was hot refluxed for 1.5 hours. The precipitate obtained was separated by filtration and dried, yielding 100 mg of (M-2). The compound obtained was identified by MALDI-MS and HPLC. Removal of the triethylammonium contained in (An-7′) was confirmed by GC. Based on these identifications, the formation of a complex salt of an azo metal complex dye anion (An-7) and a cyanine dye cation (Cat-10) was confirmed.

### Evaluation Methods

Using 10 mg of each of the dyes in Table 2 below, dye films were formed on glass sheets by the same method as that used to prepare the recording layers in Examples 1 to 23. The extinction coefficient k of each of the dye films formed was measured at a wavelength of 405 nm by spectral ellipsometry. The results are given in Table 2 below.

TABLE 2

| | | | Extinction |
|---|---|---|---|
| | (a) Azo metal | (b) Cyanine dye | coefficient k at |
| | complex dye anion | cation | 405 nm |
| (M-1) | An-4 | Cat-2 | 0.53 |
| (M-2) | An-7 | Cat-2 | 0.55 |
| (An-4′) | An-4 | — | 0.20 |
| (An-7′) | An-7 | — | 0.26 |
| (C-1) | — | — | 0.16 |

Extinction coefficient k is an intrinsic parameter of a material that depends on the wavelength λ of light. It is defined by the following equation using the complex index of refraction N, the refractive index n, and an imaginary number unit i.

N≡n−ik

In the above equation, k satisfies the following relation with absorption coefficient α and light wavelength λ:

α=4πk/λ

That is, the absorption coefficient α of a material at a given wavelength is proportional to k. Accordingly, increasing k increases the absorbance, causing light to be efficiently absorbed. Optical recording exploits decomposition of the dye when the recording layer dye is excited by light absorption, with light being converted to heat. Accordingly, achieving efficient light absorption promotes the decomposition process, and can be anticipated to increase recording sensitivity. High sensitivity permits high-speed recording, and is a topic that must be effective addressed in the next generation of optical recording media. One method of achieving this is to employ a material with a high k in the optical recording dye layer.

In the complex salt dyes obtained in Examples 24 and 25, the extinction coefficient k at a wavelength of 405 nm is higher than that of azo metal complex dyes not containing a paired cation in the form of a cyanine dye cation by a factor of equal to or greater than 2. Based on the above result, the formation of a complex salt of the azo metal complex dye and a cyanine dye was determined to markedly increase sensitivity to laser beams in the vicinity of 405 nm. Good recording and reproduction characteristics can also be anticipated when employed in optical information recording media.

The optical information recording medium, azo metal complex dye, and azo metal complex salt dye according to the present invention are not limited to the above-described modes of implementation; various configurational modification is possible without departing from the scope or spirit of the present invention.

The optical information recording medium of the present invention is suitable as an optical disk for short-wavelength lasers, such as Blu-ray disks.

Employing the azo metal complex dye and azo metal complex salt dye of the present invention as recording layer dyes permits the manufacturing of optical information recording media exhibiting good recording and reproduction characteristics and having extremely good light resistance (particularly optical information recording media permitting the recording of information by irradiation with a laser beam with a wavelength of equal to or shorter than 440 nm).

Further, the azo metal complex dye and azo metal complex salt dye of the present invention are applicable to photographic materials, color filter dyes, color converting filters, thermal transfer recording materials, inks, and the like.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. An optical information recording medium comprising a recording layer on a surface of a support, wherein
the recording layer comprises at least one azo metal complex dye that is a complex of at least one azo dye and at least one metal ion, and
the azo metal complex dye comprises equal to or more than four bonds, each of the bonds being formed between one azo dye molecule and one metal ion.

2. The optical information recording medium according to claim 1, wherein the azo metal complex dye comprises an azo metal complex dye denoted by general formula (1): 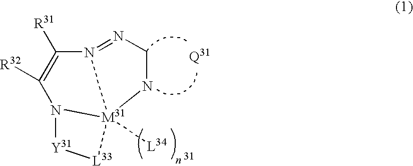
wherein, in general formula (1), M³¹ denotes a metal ion, each of L³³ and L³⁴ independently denotes an atom group comprising an atom bonded to M³¹, n³¹ denotes an integer ranging from 0 to 2, two L³⁴s are identical to or different from each other when n³¹ denotes 2, Y³¹ denotes a linking group or a single bond, Q³¹ denotes an atom group forming a nitrogen-containing heterocyclic ring with adjacent carbon and nitrogen atoms, each of R³¹ and R³² independently denotes a hydrogen atom or a substituent, and R³¹ and R³² may bond together to form a ring.

3. The optical information recording medium according to claim 1, wherein the azo metal complex dye comprises an azo metal complex dye denoted by general formula (2): 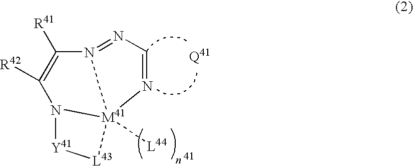
wherein, in general formula (2), M⁴¹ denotes a metal ion, L⁴³ denotes an anionic group bonded to M⁴¹, L⁴⁴ denotes an atom group comprising an atom bonded to M⁴¹, n⁴¹ denotes an integer ranging from 0 to 2, two L⁴⁴s are identical to or different from each other when n⁴¹ denotes 2, Y⁴¹ denotes a linking group or a single bond, Q⁴¹ denotes an atom group forming a nitrogen-containing heterocyclic ring with adjacent carbon and nitrogen atoms, each of R⁴¹ and R⁴² independently denotes a hydrogen atom or a substituent, and R⁴¹ and R⁴² may bond together to form a ring.

4. The optical information recording medium according to claim 1, wherein the azo metal complex dye comprises an azo metal complex dye denoted by general formula (3-1) and/or an azo metal complex dye denoted by general formula (3-2): 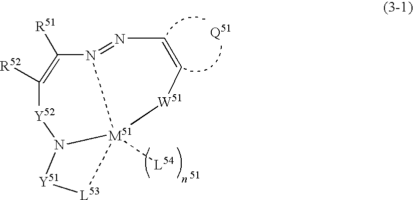
wherein, in general formula (3-1), M⁵¹ denotes a metal ion, each of L⁵³ and L⁵⁴ independently denotes an atom group comprising an atom bonded to M⁵¹, n⁵¹ denotes an integer ranging from 0 to 2, two L⁵⁴s are identical to or different from each other when n⁵¹ denotes 2, each of Y⁵¹ and Y⁵² independently denotes a linking group or a single bond, Q⁵¹ denotes an atom group forming a carbon ring or a heterocyclic ring with two adjacent carbon atoms, W⁵¹ denotes an anionic group bonded to M⁵¹, each of R⁵¹ and R⁵² independently denotes a hydrogen atom or a substituent, and R⁵¹ and R⁵² may bond together to form a ring; 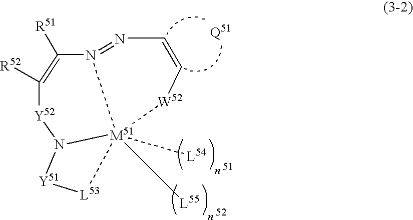
wherein, in general formula (3-2), M⁵¹ denotes a metal ion, each of L⁵³ and L⁵⁴ independently denotes an atom group comprising an atom bonded to M⁵¹, L⁵⁵ denotes an anionic ligand bonded to M⁵¹, each of n⁵¹ and n independently denotes an integer ranging from 0 to 2, two L⁵⁴s are identical to or different from each other when n⁵¹ denotes 2, two L⁵⁵s are identical to or different from each other when n⁵² denotes 2, each of Y⁵¹ and Y⁵² independently denotes a linking group or a single bond, Q⁵¹ denotes an atom group forming a carbon ring or a heterocyclic ring with two adjacent carbon atoms, W⁵² denotes a group forming a coordinate bond with M⁵¹, each of R⁵¹ and R⁵² independently denotes a hydrogen atom or a substituent, and R⁵¹ and R⁵² may bond together to form a ring.

5. The optical information recording medium according to claim 2, wherein, in general formula (1), Y³¹ denotes —SO₂— group or —C(═O)— group.

6. The optical information recording medium according to claim 3, wherein, in general formula (2), Y⁴¹ denotes —SO₂— group or —C(═O)— group.

7. The optical information recording medium according to claim 4, wherein, in general formula (3-1) and/or general formula (3-2), each of Y⁵¹ and Y⁵² independently denotes —SO₂— group or —C(═O)— group.

8. The optical information recording medium according to claim 2, wherein, in general formula (1), the nitrogen-containing heterocyclic ring that is formed with Q³¹ and the adjacent carbon and nitrogen atoms is a pyrazole ring, imidazole ring, or triazole ring.

9. The optical information recording medium according to claim 3, wherein, in general formula (2), the nitrogen-containing heterocyclic ring that is formed with Q⁴¹ and the adjacent carbon and nitrogen atoms is a pyrazole ring, imidazole ring, isooxazole ring, 1,2,4-thiadiazole ring, or triazole ring.

10. The optical information recording medium according to claim 4, wherein, in general formula (3-1), the following partial structure: 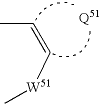
denotes one of the following partial structural formulas (C-1) to (C-5): 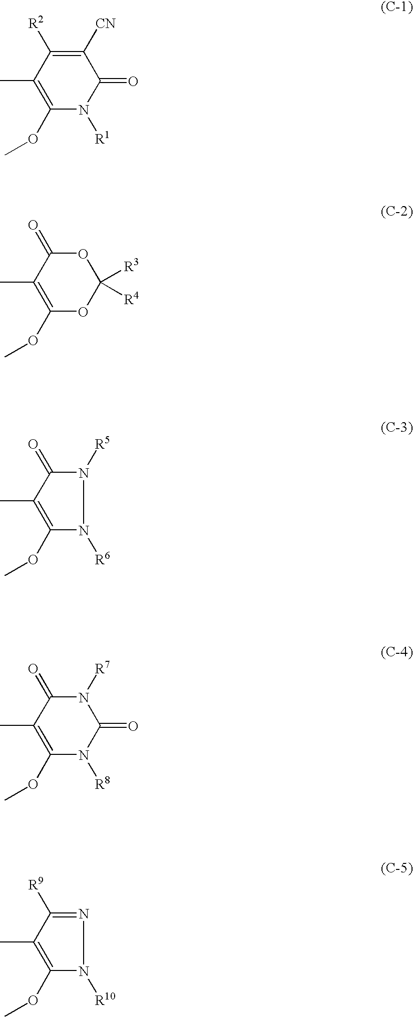
wherein each of R¹ to R¹⁰ independently denotes a hydrogen atom or a substituent, which may be joined with an adjacent substituent to form a ring.

11. The optical information recording medium according to claim 4, wherein, in general formula (3-2), the following partial structure: 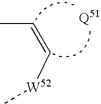
denotes one of the following partial structural formulas (C-1)′ to (C-5)′: 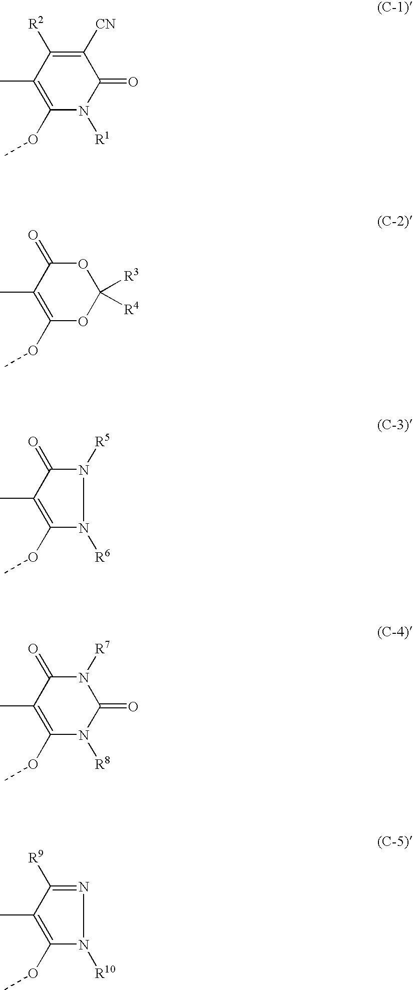
wherein each of R¹ to R¹⁰ independently denotes a hydrogen atom or a substituent, which may be joined with an adjacent substituent to form a ring.

12. The optical information recording medium according to claim 1, wherein the azo metal complex dye comprises an azo metal complex dye denoted by general formula (4): 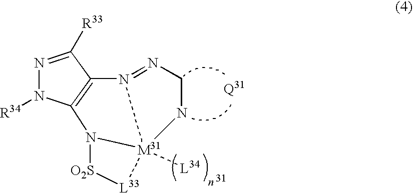
wherein, in general formula (4), M³¹ denotes a metal ion, each of L³³ and L³⁴ independently denotes an atom group comprising an atom bonded to M³¹, n³¹ denotes an integer ranging from 0 to 2, two L³⁴s are identical to or different from each other when n³¹ denotes 2, each of R³³ and R³⁴ independently denotes a hydrogen atom or a substituent, and Q³¹ denotes an atom group forming a pyrazole ring, imidazole ring, or triazole ring with adjacent carbon and nitrogen atoms.

13. The optical information recording medium according to claim 1, wherein the azo metal complex dye comprises an azo metal complex dye denoted by general formula (5): 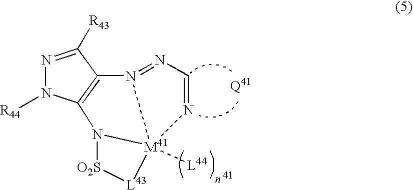
wherein, in general formula (5), M⁴¹ denotes a metal ion, L⁴³ denotes an anionic group bonded to M⁴¹, L⁴⁴ denotes an atom group comprising an atom bonded to M⁴¹, n⁴¹ denotes an integer ranging from 0 to 2, two L⁴⁴s are identical to or different from each other when n⁴¹ denotes 2, each of R⁴³ and R⁴⁴ independently denotes a hydrogen atom or a substituent, and Q⁴¹ denotes an atom group forming a nitrogen-containing heterocyclic ring with adjacent carbon and nitrogen atoms.

14. The optical information recording medium according to claim 1, wherein the azo metal complex dye comprises an azo metal complex dye denoted by general formula (6-1) and/or an azo metal complex dye denoted by general formula (6-2): 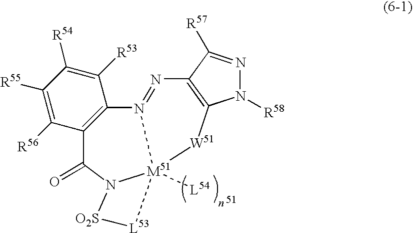
wherein, in general formula (6-1), M⁵¹ denotes a metal ion, each of L⁵³ and L⁵⁴ independently denotes an atom group comprising an atom bonded to M⁵¹, n⁵¹ denotes an integer ranging from 0 to 2, two L⁵⁴s are identical to or different from each other when n⁵¹ denotes 2, each of R⁵³ to R⁵⁸ independently denotes a hydrogen atom or a substituent, and W⁵¹ denotes an anionic group bonded to M⁵¹; 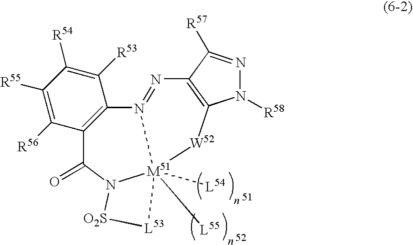
wherein, in general formula (6-2), M⁵¹ denotes a metal ion, each of L⁵³ and L⁵⁴ independently denotes an atom group comprising an atom bonded to M⁵¹, L⁵⁵ denotes an anionic ligand bonded to M⁵¹, each of n⁵¹ and n⁵² independently denotes an integer ranging from 0 to 2, two L⁵⁴s are identical to or different from each other when n⁵¹ denotes 2, two L⁵⁵s are identical to or different from each other when n denotes 2, each of R⁵³ to R⁵⁸ independently denotes a hydrogen atom or a substituent, and W⁵² denotes a group forming a coordinate bond with M⁵¹.

15. The optical information recording medium according to claim 1, wherein the recording layer comprises at least one cyanine dye.

16. The optical information recording medium according to claim 15, wherein the cyanine dye comprises a cyanine dye cation denoted by general formula (D): 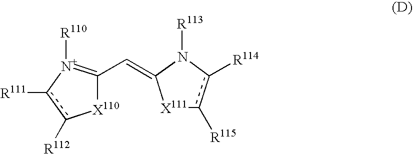
wherein, in general formula (D), each of R¹¹⁰, R¹¹¹, R¹¹², R¹¹³, R¹¹⁴, and R¹¹⁵ independently denotes a hydrogen atom or a substituent, R¹¹¹ and R¹¹² may bond together to form a ring structure, R¹¹⁴ and R¹¹⁵ may bond together to form a ring structure, and each of X¹¹⁰ and X¹¹¹ independently denotes a carbon atom, oxygen atom, nitrogen atom, or sulfur atom.

17. The optical information recording medium according to claim 16, wherein the recording layer comprises a complex salt of the azo metal complex dye and the cyanine dye cation.

18. The optical information recording medium according to claim 1, wherein the surface of the support has pregrooves with a track pitch ranging from 50 to 500 nm.

19. The optical information recording medium according to claim 1, wherein information is recorded by irradiation of a laser beam having a wavelength of equal to or shorter than 440 nm.

20. The optical information recording medium according to claim 19, further comprising a reflective layer between the support and the recording layer, wherein the laser beam is irradiated onto the recording layer from an opposite surface side, the opposite surface being opposite from the surface facing the reflective layer.

21. A method of recording information on the recording layer comprised in the optical information recording medium according to claim 1 by irradiation of a laser beam having a wavelength of equal to or shorter than 440 nm onto the optical information recording medium.

22. An azo metal complex dye denoted by general formula (4): 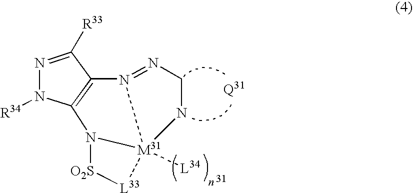
wherein, in general formula (4), M³¹ denotes a metal ion, each of L³³ and L³⁴ independently denotes an atom group comprising an atom bonded to M³¹, n³¹ denotes an integer ranging from 0 to 2, two L³⁴s are identical to or different from each other when n³¹ denotes 2, each of R³³ and R³⁴ independently denotes a hydrogen atom or a substituent, and Q³¹ denotes an atom group forming a pyrazole ring, imidazole ring, or triazole ring with adjacent carbon and nitrogen atoms.

23. An azo metal complex dye denoted by general formula (5): 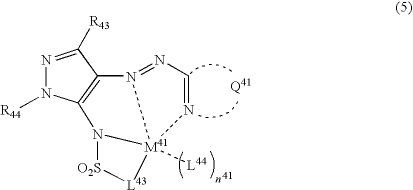
wherein, in general formula (5), M⁴¹ denotes a metal ion, L⁴³ denotes an anionic group bonded to M⁴¹, L⁴⁴ denotes an atom group comprising an atom bonded to M⁴¹, n⁴¹ denotes an integer ranging from 0 to 2, two L⁴⁴s are identical to or different from each other when n⁴¹ denotes 2, each of R⁴³ and R⁴⁴ independently denotes a hydrogen atom or a substituent, and Q⁴¹ denotes an atom group forming a nitrogen-containing heterocyclic ring with adjacent carbon and nitrogen atoms.

24. An azo metal complex dye denoted by general formula (6-1) or (6-2): 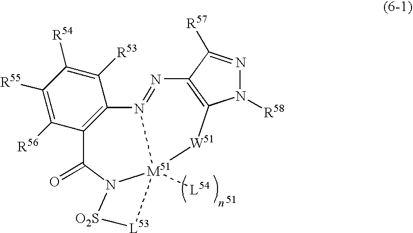
wherein, in general formula (6-1), M⁵¹ denotes a metal ion, each of L⁵³ and L⁵⁴ independently denotes an atom group comprising an atom bonded to M⁵¹, n⁵¹ denotes an integer ranging from 0 to 2, two L⁵⁴s are identical to or different from each other when n⁵¹ denotes 2, each of R⁵³ to R⁵⁸ independently denotes a hydrogen atom or a substituent, and W⁵¹ denotes an anionic group bonded to M⁵¹; 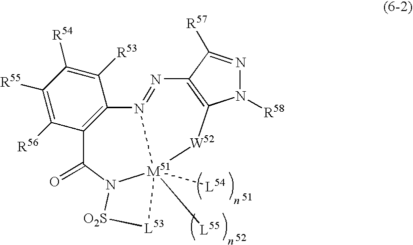
wherein, in general formula (6-2), M⁵¹ denotes a metal ion, each of L⁵³ and L⁵⁴ independently denotes an atom group comprising an atom bonded to M⁵¹, L⁵⁵ denotes an anionic ligand bonded to M⁵¹, each of n⁵¹ and n⁵² independently denotes an integer ranging from 0 to 2, two L⁵⁴s are identical to or different from each other when n⁵¹ denotes 2, two L⁵⁵s are identical to or different from each other when n⁵² denotes 2, each of R⁵³ to R⁵⁸ independently denotes a hydrogen atom or a substituent, and W⁵² denotes a group forming a coordinate bond with M⁵¹.

25. An azo metal complex salt dye of a cyanine dye cation denoted by general formula (D) and an azo metal complex dye denoted by general formula (4), (5), (6-1) or (6-2): 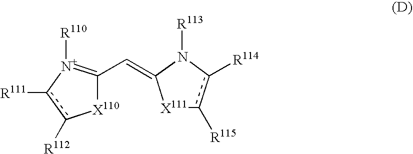
wherein, in general formula (D), each of R¹¹⁰, R¹¹¹, R¹¹², R¹¹³, R¹¹⁴, and R¹¹⁵ independently denotes a hydrogen atom or a substituent, R¹¹¹ and R¹¹² may bond together to form a ring structure, R¹¹⁴ and R¹¹⁵ may bond together to form a ring structure, and each of X¹¹⁰ and X¹¹¹ independently denotes a carbon atom, oxygen atom, nitrogen atom, or sulfur atom; 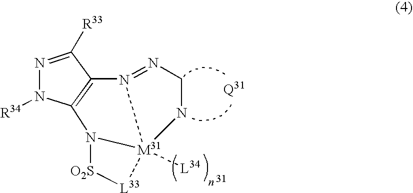
wherein, in general formula (4), M³¹ denotes a metal ion, each of L³³ and L³⁴ independently denotes an atom group comprising an atom bonded to M³¹, n³¹ denotes an integer ranging from 0 to 2, two L³⁴s are identical to or different from each other when n³¹ denotes 2, each of R³³ and R³⁴ independently denotes a hydrogen atom or a substituent, and Q³¹ denotes an atom group forming a pyrazole ring, imidazole ring, or triazole ring with adjacent carbon and nitrogen atoms; 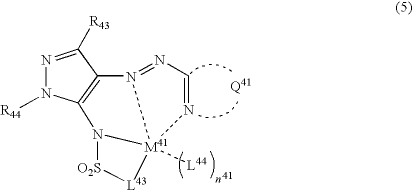
wherein, in general formula (5), M⁴¹ denotes a metal ion, L⁴³ denotes an anionic group bonded to M⁴¹, L⁴⁴ denotes an atom group comprising an atom bonded to M⁴¹, n⁴¹ denotes an integer ranging from 0 to 2, two L⁴⁴s are identical to or different from each other when n⁴¹ denotes 2, each of R⁴³ and R⁴⁴ independently denotes a hydrogen atom or a substituent, and Q⁴¹ denotes an atom group forming a nitrogen-containing heterocyclic ring with adjacent carbon and nitrogen atoms; 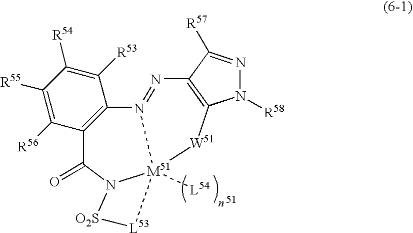
wherein, in general formula (6-1), M⁵¹ denotes a metal ion, each of L⁵³ and L⁵⁴ independently denotes an atom group comprising an atom bonded to M⁵¹, n⁵¹ denotes an integer ranging from 0 to 2, two L⁵⁴s are identical to or different from each other when n⁵¹ denotes 2, each of R⁵³ to R⁵⁸ independently denotes a hydrogen atom or a substituent, and W⁵¹ denotes an anionic group bonded to M⁵¹; 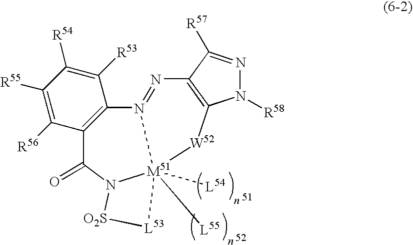
wherein, in general formula (6-2), M⁵¹ denotes a metal ion, each of L⁵³ and L⁵⁴ independently denotes an atom group comprising an atom bonded to M⁵¹, L⁵⁵ denotes an anionic ligand bonded to M⁵¹, each of n⁵¹ and n⁵² independently denotes an integer ranging from 0 to 2, two L⁵⁴s are identical to or different from each other when n⁵¹ denotes 2, two L⁵⁵s are identical to or different from each other when n⁵² denotes 2, each of R⁵³ to R⁵⁸ independently denotes a hydrogen atom or a substituent, and W⁵² denotes a group forming a coordinate bond with M⁵¹.
